(19) United States
(12) Patent Application Publication
(10) Pub. No.: US 2024/0318769 A1
(43) Pub. Date: Sep. 26, 2024

(54) LEVELING PAD SYSTEM AND METHOD OF USE

(71) Applicant: DICA Marketing Company, Urbandale, IA (US)

(72) Inventors: Wayne Margetts, Ladysmith (CA); Dwight Haworth, Panora, IA (US)

(21) Appl. No.: 18/613,871

(22) Filed: Mar. 22, 2024

Related U.S. Application Data
(60) Provisional application No. 63/492,138, filed on Mar. 24, 2023.

(51) Int. Cl. F16M 11/20

(52) U.S. Cl. CPC F16M 11/20

(57) ABSTRACT

In one or more arrangements, a leveling pad system for supporting a foot of a piece of equipment is presented which has a top member, middle member, a bottom member, and an axle. In one or more arrangements, the top member has a top surface and an angled mating surface, and the bottom member has a bottom surface and an angled mating surface. In this arrangement the axle is inserted into the top member, the middle member and the bottom member, the top member rotates independent of the bottom member, and the bottom member rotates independent of the top member. When the bottom member is rotated, the top surface of the top member moves to a desired slope in a first direction and when the top member is rotated the top surface of the top member moves to a desired slope in a second direction.

### CROSS REFERENCE TO RELATED APPLICATION

This application claims priority under 35 U.S.C. § 119 to provisional application Ser. No. 63/492,138 filed Mar. 24, 2023, and titled “Leveling Pad System and Method of Use”, which is hereby incorporated by reference in its entirety.

### FIELD OF THE DISCLOSURE

This disclosure relates to a leveling pad system. More specifically, this disclosure relates to a leveling pad system intended to provide a level surface upon which a foot of a piece of equipment may rest.

### OVERVIEW OF THE DISCLOSURE

Outriggers are frequently used to provide additional stability and support as cranes, boom trucks, aerial work platforms, concrete pump trucks, and the like. There are countless types, forms and designs of outriggers known in the art. Generally speaking, these outriggers extend outward from the body of the vehicle or equipment and engage the ground thereby giving a greater base of stability which increases safety and allows the vehicle or equipment to move heavier loads or increase its reach with greater security and safety.

Pads, mats, blocking, or cribbing are sometimes used to provide a foundation for outriggers, stabilizers, jacks or similar devices and the outriggers, stabilizers, jacks, or similar devices may rest on the pad, mat, blocking or cribbing. Since the outriggers, stabilizers, jacks, or similar devices are typically used to provide a stable base which allows the equipment to move or support heavy loads and increase its reach, the pads or mats must be able to withstand a great deal of force and do this without moving or slipping, thereby jeopardizing the stability of the outrigger and the safety of the operator and other individuals and property in the area surrounding the outrigger. Pads, mats, blocking and cribbing must be able to effectively distribute the exerted load and pressures from the outriggers to the supporting ground under the pads, mats, blocking and cribbing.

While pads, mats, blocking, or cribbing can help provide a foundation, they cannot always provide a level foundation for outriggers, stabilizers, jacks, or similar devices. Outriggers, stabilizers, jacks, or similar devices must be utilized in varying terrains and locations and the slope of the ground or floor at these various locations may not be level. Certain outriggers, stabilizers, jacks, or similar devices have feet that can accommodate slight slopes and still provide stability to the piece of equipment it is supporting. For example, certain outriggers include feet which are connected to legs of the outrigger through ball joints and such ball joints can allow the foot to angle up to approximately 5-degrees without sacrificing the stability or structural integrity of the outrigger; however once the slope of the ground exceeds approximately 5-degrees, the angle of the foot may not be supported by the ball joint and the foot may shear off or otherwise fail, causing extremely dangerous issues with the outrigger and the piece of equipment it is supporting. Even when the outrigger, stabilizer, jack, or similar device can accommodate for some slope in the ground or floor upon which it is resting, it is still preferred to have the foot of the outrigger, stabilizer, jack, or similar device rest on a level surface for increased security and stability.

Therefore, for all the reasons stated above, and the reasons stated below, there is a need in the art for an improved leveling pad system and method of use which can provide a level surface upon which a foot of a piece of equipment may rest. Thus, it is a primary objective of the disclosure to provide a leveling pad system and method of use that improves upon the state of the art.

Another objective of the disclosure is to provide a leveling pad system that is safe to operate.

Yet another objective of the disclosure is to provide a leveling pad system that is rigid and does not fail or slip when placed under heavy loads.

Another objective of the disclosure is to provide a leveling pad system that provides a level and stable base when in use.

Yet another objective of the disclosure is to provide a leveling pad system that is relatively easy to build.

Another objective of the disclosure is to provide a leveling pad system that is relatively friendly to build.

Yet another objective of the disclosure is to provide a leveling pad system that can be built relatively quickly and efficiently.

Another objective of the disclosure is to provide a leveling pad system that is easy to operate.

Yet another objective of the disclosure is to provide a leveling pad system that is relatively cost friendly to manufacture.

Another objective of the disclosure is to provide a leveling pad system that is relatively easy to transport.

Yet another objective of the disclosure is to provide a leveling pad system that is aesthetically appealing.

Another objective of the disclosure is to provide a leveling pad system that is robust.

Yet another objective of the disclosure is to provide a leveling pad system that is easy to adjust.

Another objective of the disclosure is to provide a leveling pad system that is relatively inexpensive.

Yet another objective of the disclosure is to provide a leveling pad system that is not easily susceptible to wear and tear.

Another objective of the disclosure is to provide a leveling pad system that has a long useful life.

Yet another objective of the disclosure is to provide a leveling pad system that is efficient to use and operate.

These and other objects, features, or advantages of the disclosure will become apparent from the specification, figures, and claims.

### SUMMARY OF THE DISCLOSURE

In one or more arrangements, a leveling pad system is presented, which has a top member, a middle member, a bottom member, and an axle. In one or more arrangements, the top member has a top surface and a mating surface that extends at an angle downward relative to the top surface. In one or more arrangements, the bottom member has a bottom surface, a mating surface that extends at an angle upward relative to the bottom surface. In one or more arrangements, the middle member has a top surface and a bottom surface. In one or more arrangements, the axle is configured to be inserted into the top member and the bottom member.

In one or more arrangements, the top member rotates about the axle independent of the bottom member, and the bottom member rotates about the axle independent of the top member. When the bottom member is rotated about the axle, the top surface of the top member moves to a desired slope in a first direction and when the top member is rotated about the axle the top surface of the top member moves to a desired slope in a second direction. In one or more arrangements, the bottom member is configured to rest on a surface and the top member is configured to receive and support a foot of a piece of equipment. In one or more arrangements, the middle member is configured to take pressure from the top member and/or the bottom member due to potential lateral movement.

In one or more arrangements, the surface is a piece of ground, a floor, a pad, a mat, blocking, or cribbing.

In one or more arrangements, the piece of equipment is an outrigger, stabilizer, or jack of a crane, a boom truck, an aerial work platform, or a concrete pump truck.

In one or more arrangements, the foot is a foot of an outrigger and wherein the outrigger is configured to provide support to the piece of equipment when in operation.

In one or more arrangements, the mating surface of the top member extends at approximately a 5-degree angle downward relative to the top surface of the top member.

In one or more arrangements, the mating surface of the bottom member extends at approximately a 5-degree angle upward relative to the bottom surface of the bottom member.

In one or more arrangements, the axle extends in a perpendicular manner relative to the mating surface of the top member and the mating surface of the bottom member.

In one or more arrangements, when the bottom member is rotated such that the top surface of the top member is at the desired slope in the first direction the top surface of the top member is approximately level in the first direction.

In one or more arrangements, when the top member is rotated such that the top surface of the top member is at the desired slope in the second direction the top surface of the top member is approximately level in the second direction.

In one or more arrangements, the surface is a sloped surface, and when the bottom member is rotated to the desired slope the top surface of the top member is level in the first direction. Also in this arrangement, when the top member is rotated to the desired slope the top surface of the top member is level in the second direction.

In one or more arrangements, the mating surface of the top member is configured to engage with the mating surface of the bottom member and the mating surface of the top member, and the mating surface of the bottom member hold the top member and bottom member in secured engagement.

In one or more arrangements, a leveling pad system is presented, which has a top member, a middle member, a bottom member, and an axle. In one or more arrangements, the top member has a top surface and a mating surface that extends at an angle downward relative to the top surface. In one or more arrangements, the bottom member has a bottom surface, a mating surface that extends at an angle upward relative to the bottom surface. In one or more arrangements, the axle is configured to be inserted into the top member and the bottom member. In one or more arrangements, the top member rotates about the axle independent of the bottom member, and the bottom member rotates about the axle independent of the top member. In one or more arrangements, when the bottom member is rotated about the axle to a desired position, the top surface of the top member is approximately level in a first direction and when the top member is rotated about the axle to a desired position the top surface of the top member is level in a second direction. In one or more arrangements, the bottom member is configured to rest on a sloped surface and the top member is configured to receive and support a foot of a piece of equipment.

In one or more arrangements, the surface is a piece of ground, a floor, a pad, a mat, blocking, or cribbing.

In one or more arrangements, the piece of equipment is an outrigger, stabilizer, or jack of a crane, a boom truck, an aerial work platform, or a concrete pump truck.

In one or more arrangements, the foot is a foot of an outrigger and wherein the outrigger is configured to provide support to the piece of equipment when in operation.

In one or more arrangements, the mating surface of the top member extends at approximately a 5-degree angle downward relative to the top surface of the top member.

In one or more arrangements, the mating surface of the bottom member extends at approximately a 5-degree angle upward relative to the bottom surface of the bottom member.

In one or more arrangements, the mating surface of the top member is configured to engage with the mating surface of the bottom member and the mating surface of the top member, and the mating surface of the bottom member hold the top member and bottom member in secured engagement.

### BRIEF DESCRIPTION OF THE FIGURES

FIG. 1 is a perspective view of an equipment leveling system, in accordance with one or more arrangements; the view showing the top member and the bottom member.

FIG. 2 is another perspective view of an equipment leveling system, in accordance with one or more arrangements; the view showing the top member, the bottom member, and the handles.

FIG. 3 is another perspective view of an equipment leveling system, in accordance with one or more arrangements; the view showing the top member having a handle and the bottom member having a handle.

FIG. 4 is another perspective view of an equipment leveling system, in accordance with one or more arrangements; the view showing the top member, the bottom member, and the handles.

FIG. 5 is another perspective view of an equipment leveling system, in accordance with one or more arrangements; the view showing the top member, the bottom member, axel, and the handles.

FIG. 6 is another perspective view of an equipment leveling system, in accordance with one or more arrangements; the view showing the top member, the bottom member, axel, and the handles.

FIG. 7 is another perspective view of an equipment leveling system, in accordance with one or more arrangements; the view showing the top member having a recess configured to fit the middle member, the bottom member, axel, and the handles.

FIG. 8 is another perspective view of an equipment leveling system, in accordance with one or more arrangements; the view showing the top member, the bottom member, axel, and the handles.

FIG. 9A is an additional perspective view of an equipment leveling system, in accordance with one or more arrangements; the view showing the top member, the bottom member, axel, and the handles; the view further showing the independent rotations of the top member and the bottom member.

FIG. 9B is an additional perspective view of an equipment leveling system, in accordance with one or more arrangements; the view showing the top member, the bottom member, axel, and the handles; the view further showing the independent rotations of the top member and the bottom member.

FIG. 9C is an additional perspective view of an equipment leveling system, in accordance with one or more arrangements; the view showing the top member, the bottom member, axel, and the handles; the view further showing the independent rotations of the top member and the bottom member.

FIG. 9D is an additional perspective view of an equipment leveling system, in accordance with one or more arrangements; the view showing the top member, the bottom member, axel, and the handles; the view further showing the independent rotations of the top member and the bottom member.

FIG. 10 is an elevation view of an equipment leveling system, in accordance with one or more arrangements; the view showing a section view of the top member having a downward angled mating surface, the middle member having a downward angle, the bottom member having an upward angled mating surface, the apertures, the handles and the axle operably connecting the top member, middle member, and bottom member.

FIG. 11 is an exploded view of an equipment leveling system, in accordance with one or more arrangements; the view showing, the top member having a recess to fit a portion of the middle member, the downward angled middle member, bottom member having a recess to fit a portion of the middle member, the handles, and the axle.

FIG. 12A is an elevation view of an equipment leveling system, in accordance with one or more arrangements; the view showing a section view of the top member having a downward angled mating surface, bottom member having an upward angled mating surface, the handles and the axle operably connecting the top member and the bottom member, the view showing a flat top surface of the top member.

FIG. 12B is an elevation view of an equipment leveling system, in accordance with one or more arrangements; the view showing a section view of the top member having a downward angled mating surface, bottom member having an upward angled mating surface, the handles and the axle operably connecting the top member and the bottom member, the view showing a sloped top surface of the top member.

FIG. 13A is an exploded view of an equipment leveling system, in accordance with one or more arrangements; the view showing the top member with a handle, the bottom member, with a handle and an aperture configured to fit the axle, and the axle.

FIG. 13B is another exploded view of an equipment leveling system, in accordance with one or more arrangements; the view showing the top member with a handle, the bottom member, with a handle and an aperture configured to fit the axle, and the axle placed within the aperture of the bottom member.

FIG. 13C is a perspective view of an equipment leveling system, in accordance with one or more arrangements; the view showing the mating surface of the top member securely engaged to the mating surface of the bottom member.

FIG. 14 is an elevation view of the top member of an equipment leveling system, in accordance with one or more arrangements; the view showing the top surface of the top member, the axle, the aperture of the top member and the aperture of the bottom member.

FIG. 15 is another elevation view of the top member of an equipment leveling system, in accordance with one or more arrangements; the view showing the top surface of the top member, a handle attached to the top member and the axle.

FIG. 16 is another elevation view of the top member of an equipment leveling system, in accordance with one or more arrangements; the view showing a sectional top view; the view showing the mating surface, the handle attached to the top member, and the recess of the top member configured to fit the middle member, and the level pocket of the top member.

FIG. 17 is another elevation view of the top member of an equipment leveling system, in accordance with one or more arrangements; the view showing a sectional top view; the view showing the mating of the top member, the handle attached to the top member, and the recess configured to fit the middle member.

FIG. 18 is another elevation view of the top member of an equipment leveling system, in accordance with one or more arrangements; the view showing a sectional side view of the top member; the view showing the top surface, the angled mating surface of the top member, the aperture configured to fit the axle, a connection member configured to fit the handle, and the recess configured to fit a portion of the middle member; the view showing a height of the top member.

FIG. 19 is another elevation view of the top member of an equipment leveling system, in accordance with one or more arrangements; the view showing a sectional side of the top member; the view showing the top surface of the top member, the downward angled mating surface of the top member, and the aperture configured to fit the axle.

FIG. 20 is another elevation view of the top member of an equipment leveling system, in accordance with one or more arrangements; the view showing the flat top surface of the top member, the downward angled mating surface of the top member, the handle, and the aperture configured to fit the axle.

FIG. 21 is a perspective view of the top member of an equipment leveling system, in accordance with one or more arrangements; the view showing a recess in the mating surface of the top member configured to fit the middle member and an aperture configured to fit the axle; the view showing a diameter of the recess and a diameter of the top member.

FIG. 22 is a perspective view of the bottom member, in accordance with one or more arrangements; the view showing the bottom surface of the bottom member, the mating surface of the bottom member, the aperture of the bottom member configured to fit the axle, and the axle.

FIG. 23 is an elevation view of the bottom member of an equipment leveling system, in accordance with one or more arrangements; the view showing the mating surface of the bottom member, the view showing a recess configured to fit the middle member, aperture configured to fit the axle, the view showing the level pocket of the bottom member, the view further showing the handle.

FIG. 24 is an elevation view of the bottom member of an equipment leveling system, in accordance with one or more arrangements; the view showing the mating surface of the bottom member having a recess configured to fit the middle member, an aperture configured to fit the axle and the level pocket.

FIG. 25 is an elevation view of the bottom member of an equipment leveling system, in accordance with one or more arrangements; the view showing a section of the side view of the bottom member, the view showing the upward angle of the mating surface, the recess of the mating surface configured to fit the middle member, the bottom surface of the bottom member, a connection member configured to fit the handle, and an aperture configured to fit the axle.

FIG. 26 is another elevation view of the bottom member of an equipment leveling system, in accordance with one or more arrangements; the view showing a sectional view of the bottom member; the view showing the upward angled mating surface of the bottom member, the flat bottom surface of the bottom member, and the aperture configured to fit the axle.

FIG. 27 is a perspective view of the bottom member of an equipment leveling system, in accordance with one or more arrangements; the view showing a recess in the mating surface of the bottom member configured to fit the middle member and an aperture configured to fit the axle; the view showing a diameter of the recess and a diameter of the bottom member; the view showing a height of the bottom member.

FIG. 28 is a perspective view of the middle member of an equipment leveling system, in accordance with one or more arrangements; showing the top surface of the middle member, the bottom surface of the middle member, and the aperture configured to fit the axle.

FIG. 29 is an elevation view of the middle member of an equipment leveling system, in accordance with one or more arrangements; the view showing the top surface of the middle member, and the aperture configured to fit the axle.

FIG. 30 is an elevation view of the middle member of an equipment leveling system, in accordance with one or more arrangements; the view showing a diameter of the middle member, a height of the middle member, and the aperture configured to fit the axle.

FIG. 31 is an elevation view of an equipment leveling system, in accordance with one or more arrangements; the view showing the top member, the bottom member, and the axle, the view showing a dashed line that represents the engagement of the top member to the bottom member.

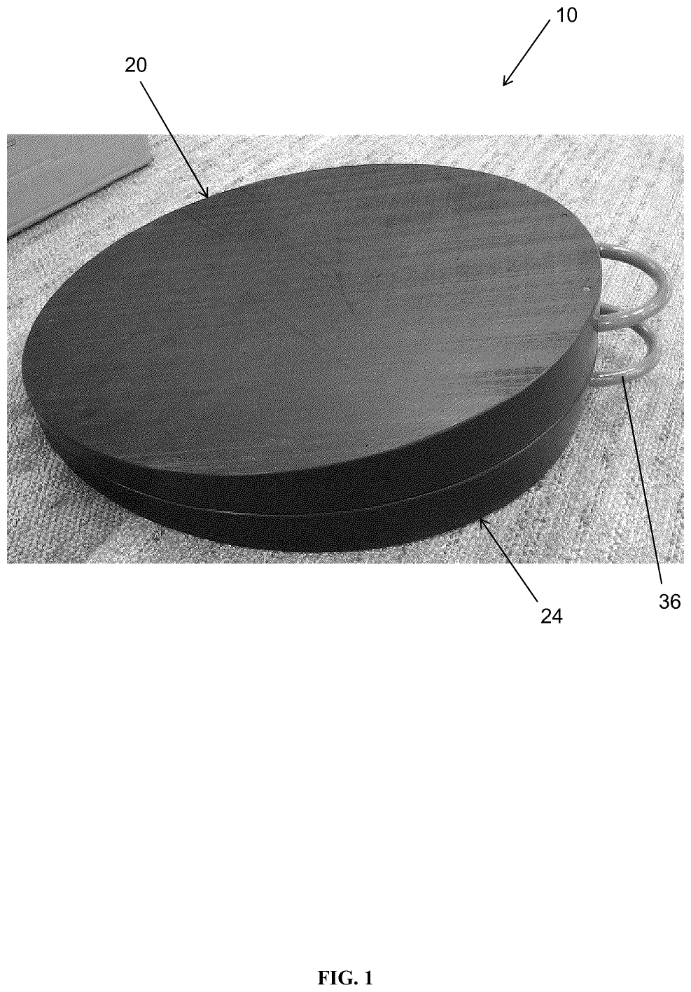

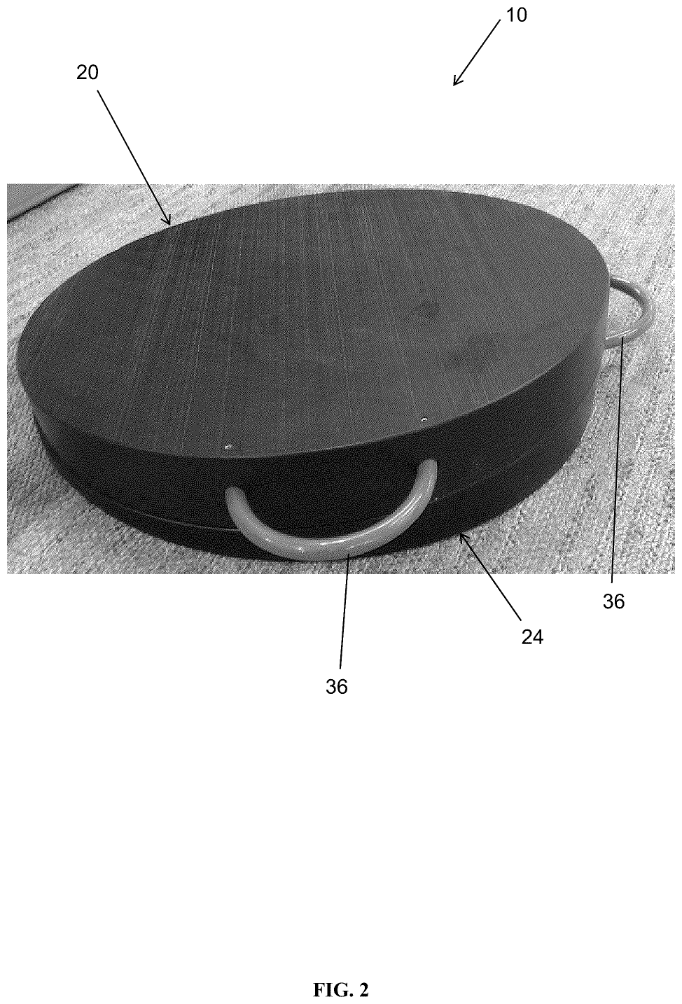

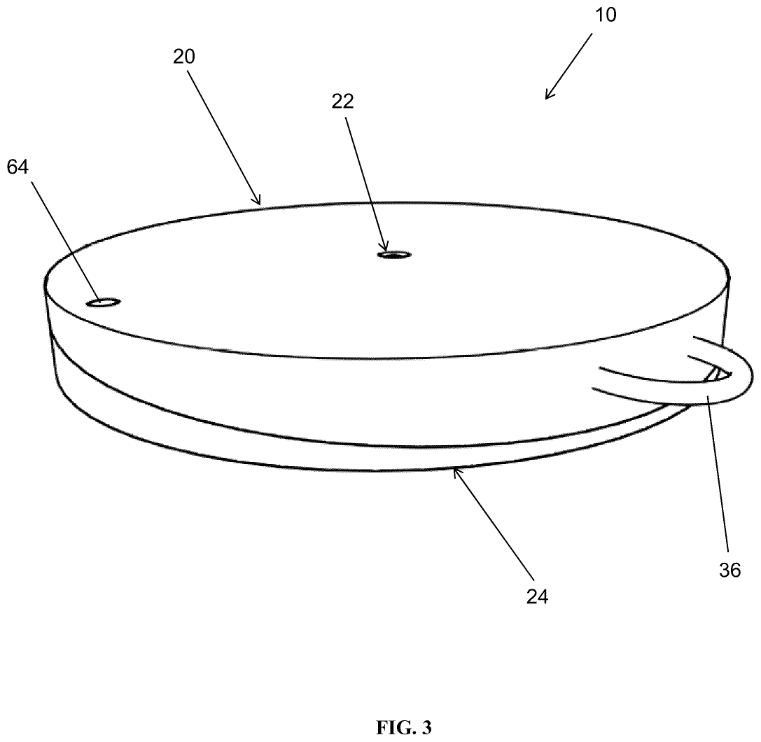

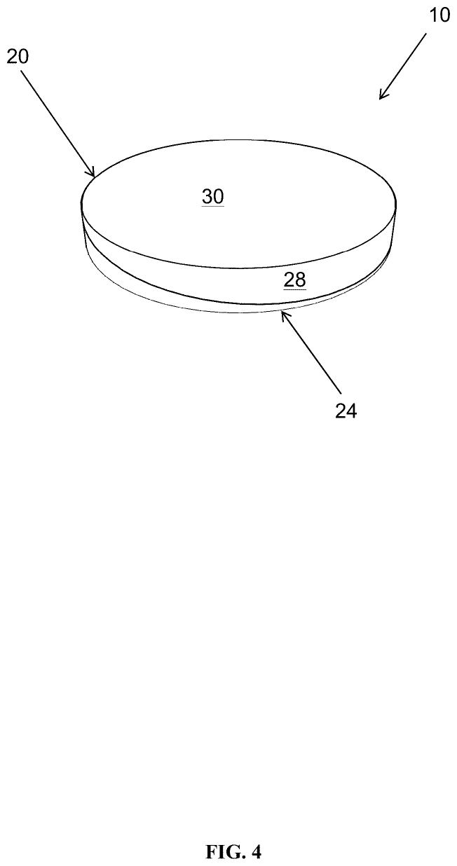

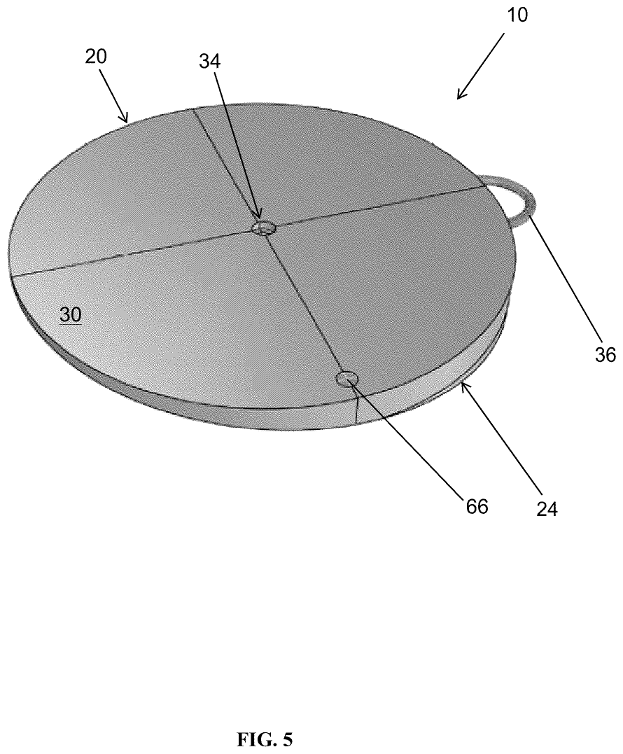

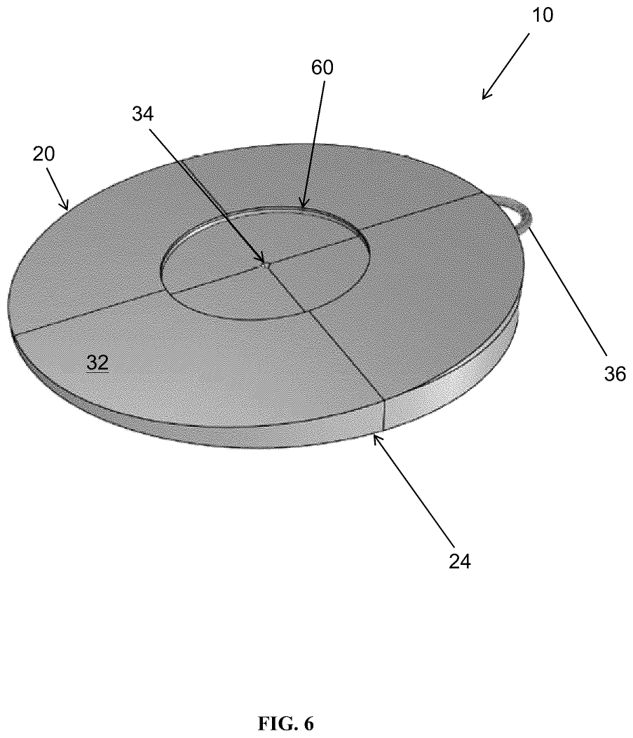

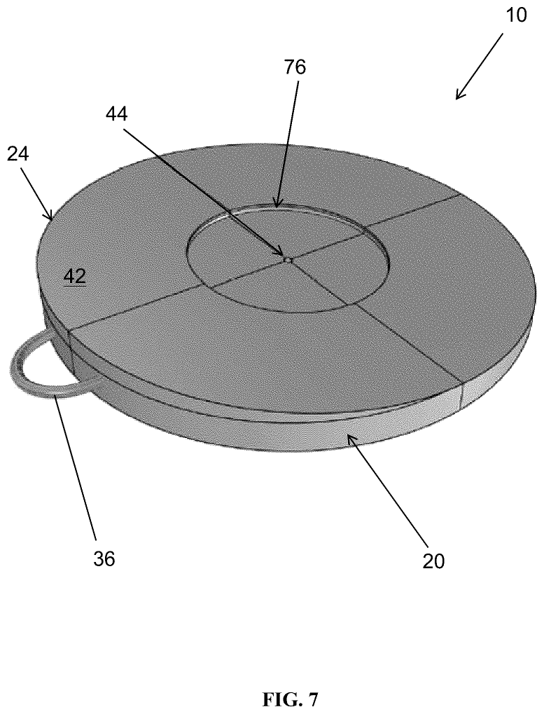

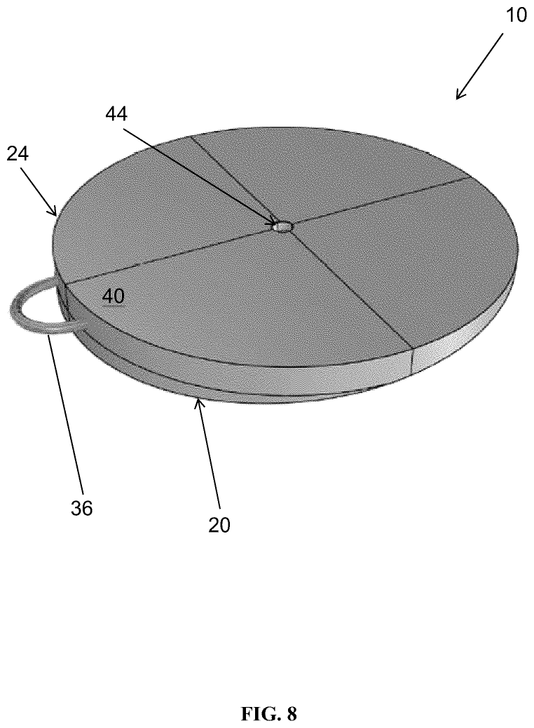

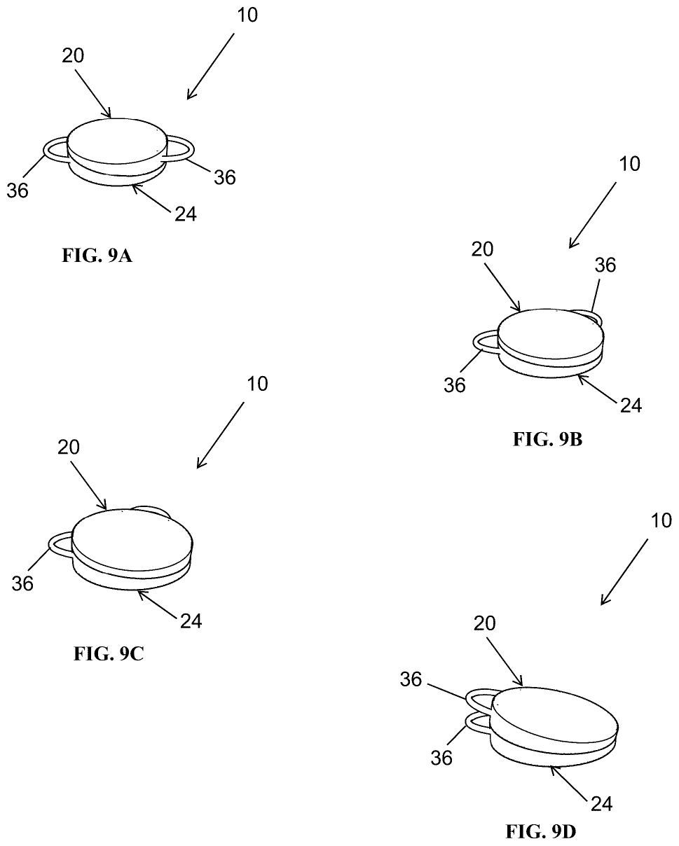

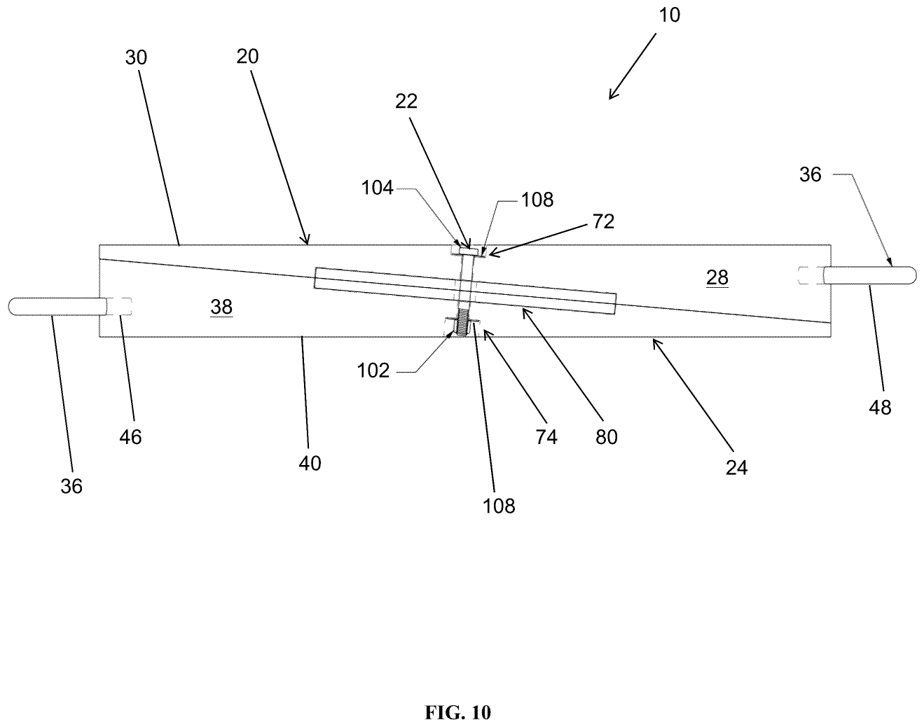

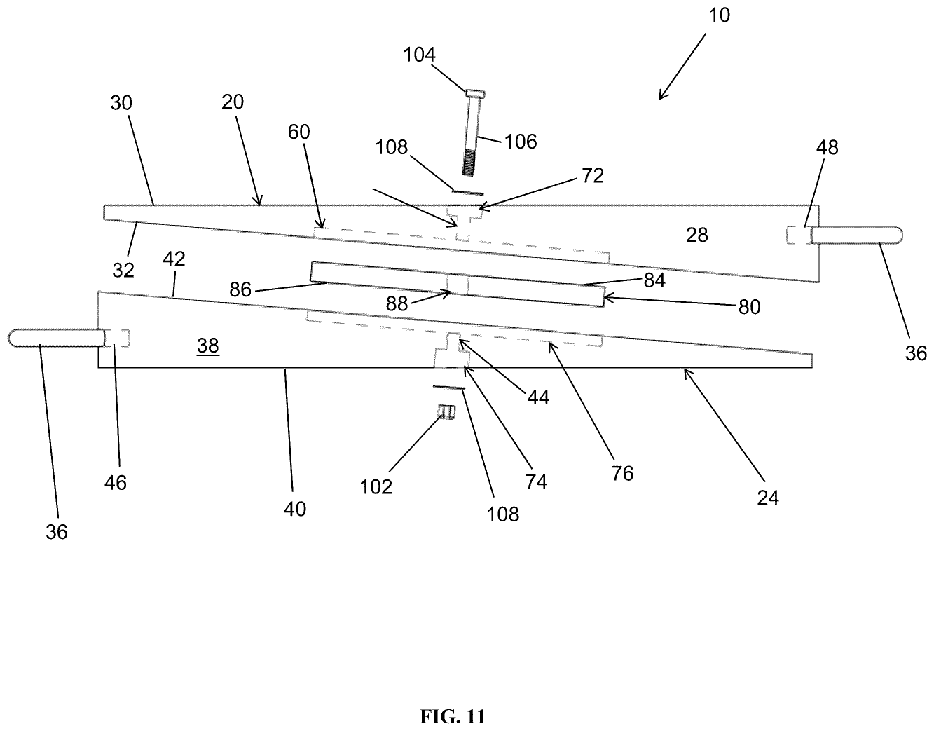

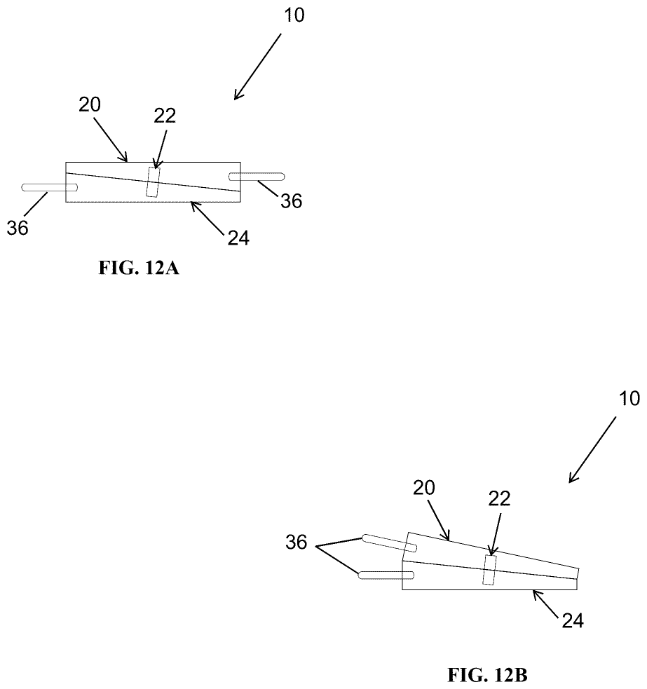

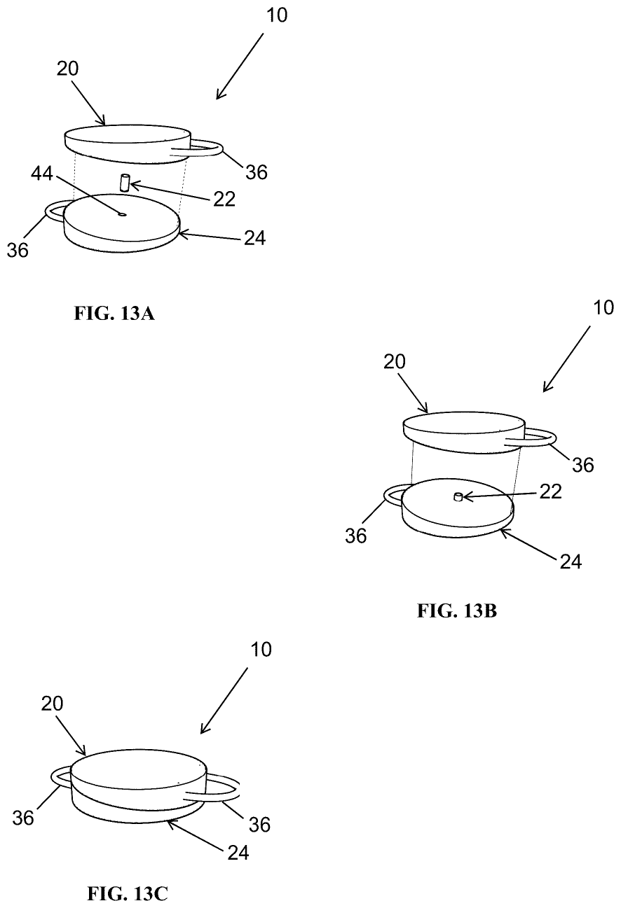

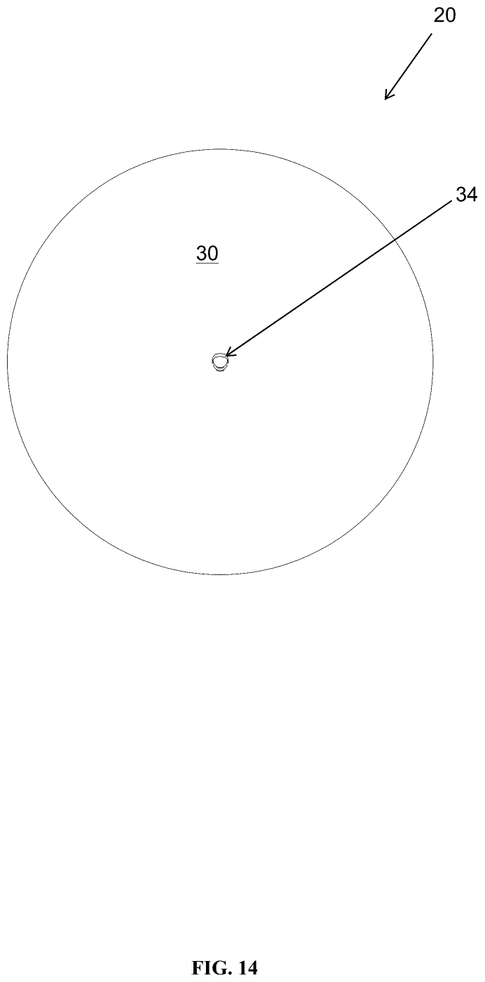

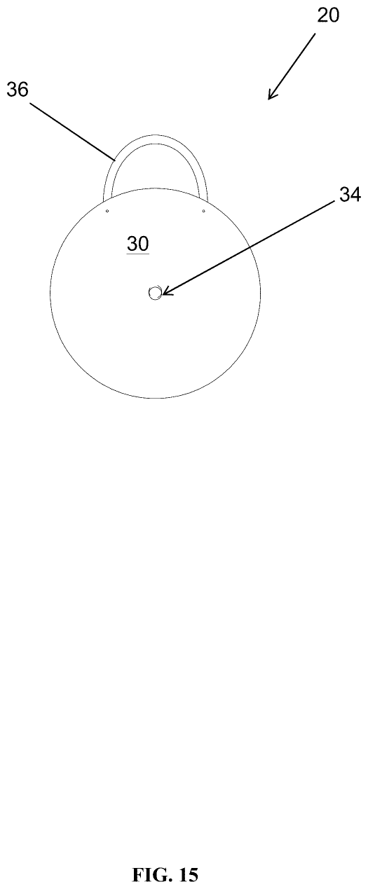

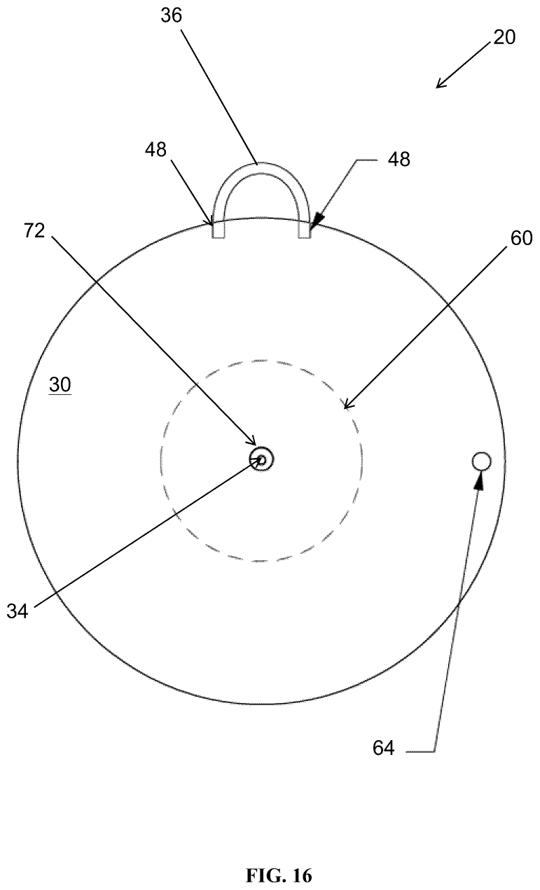

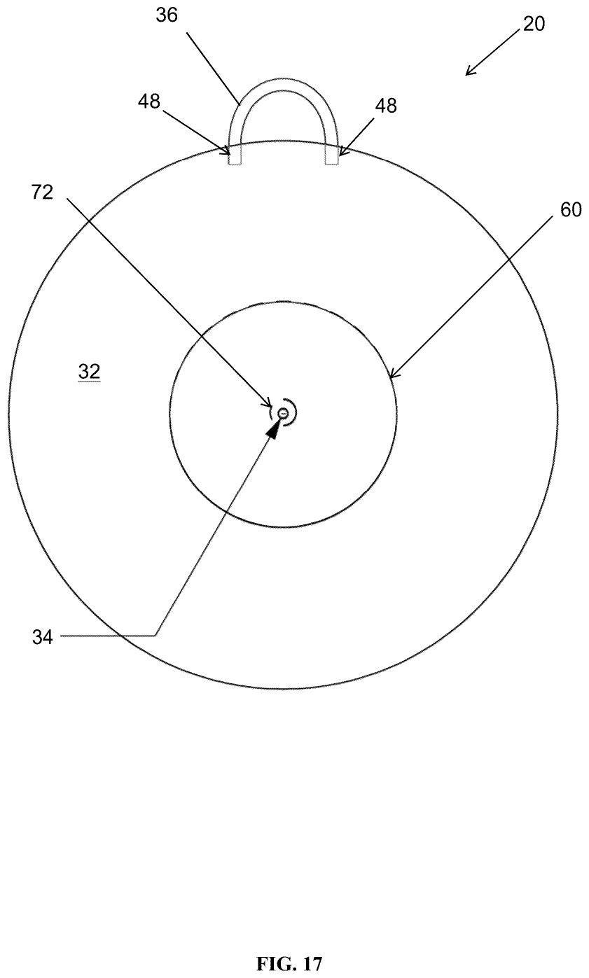

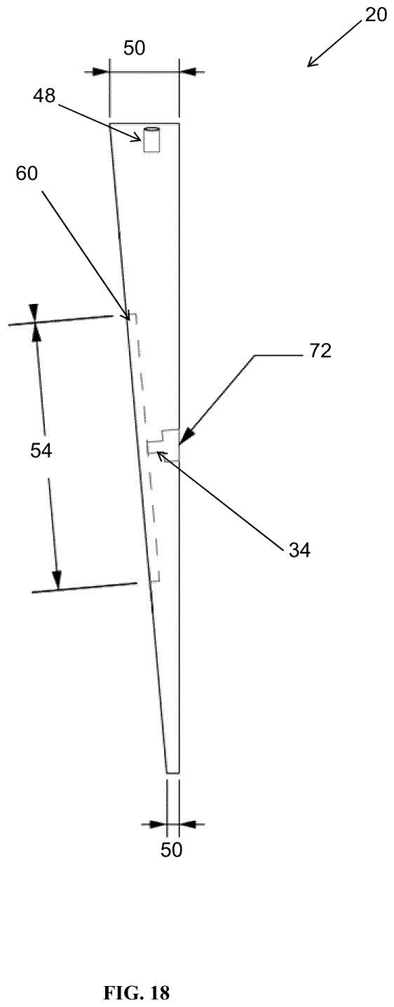

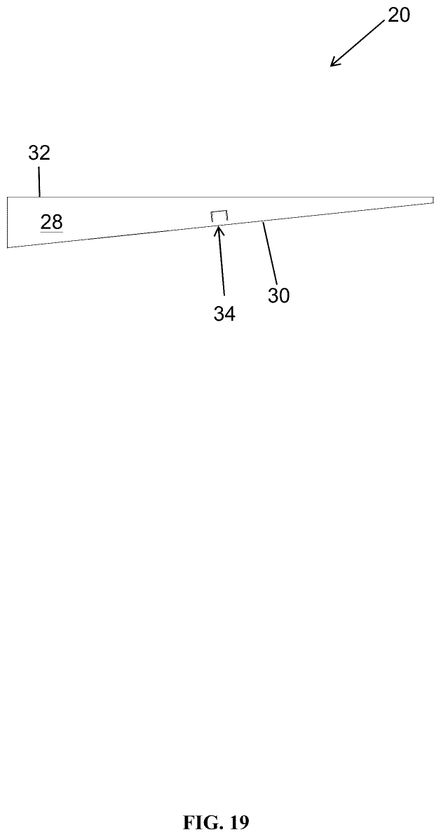

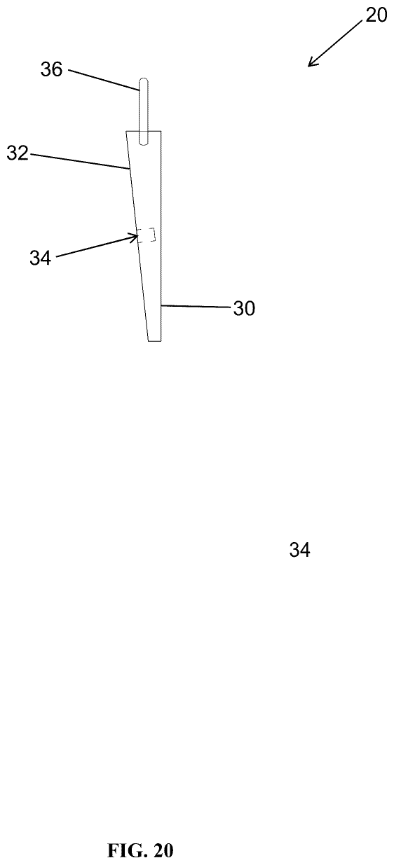

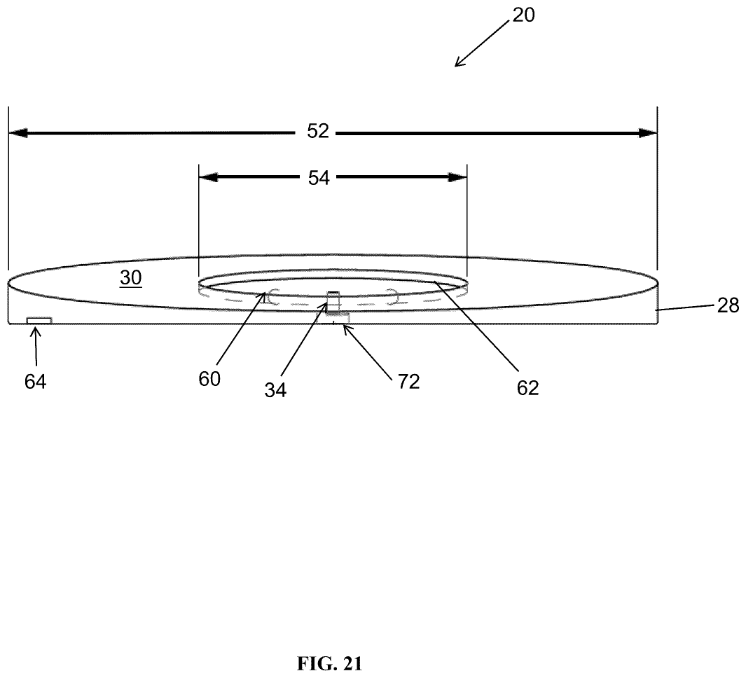

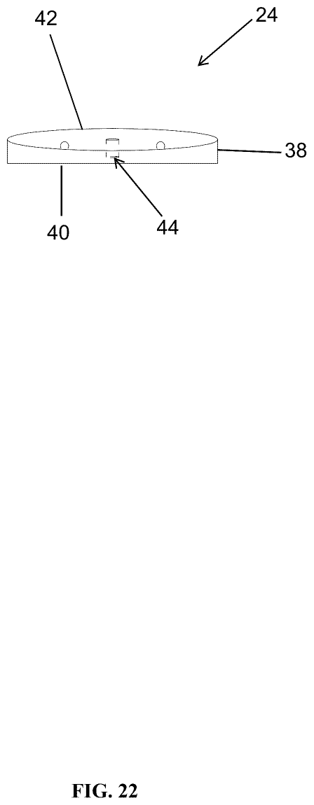

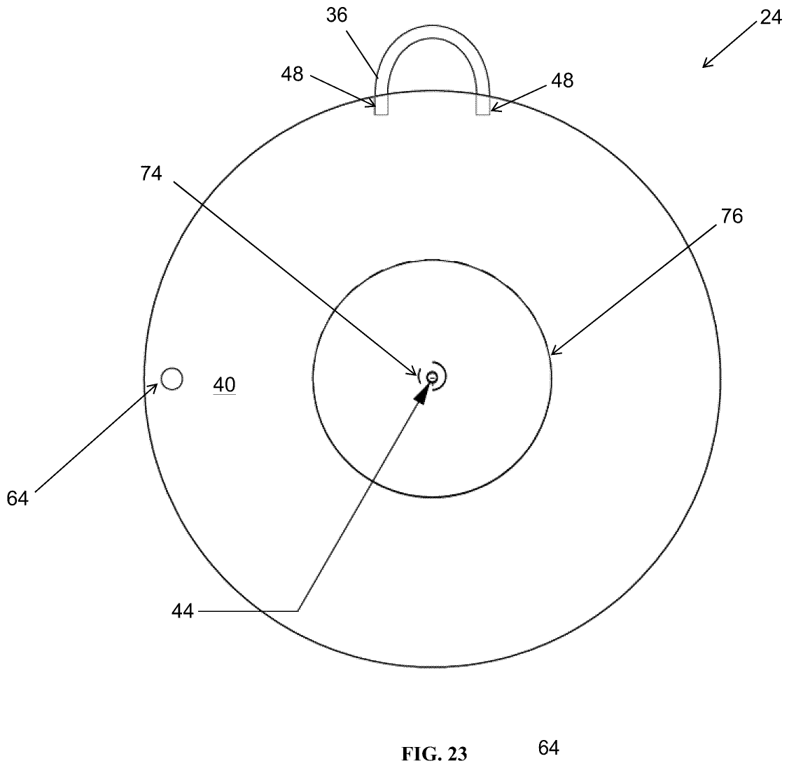

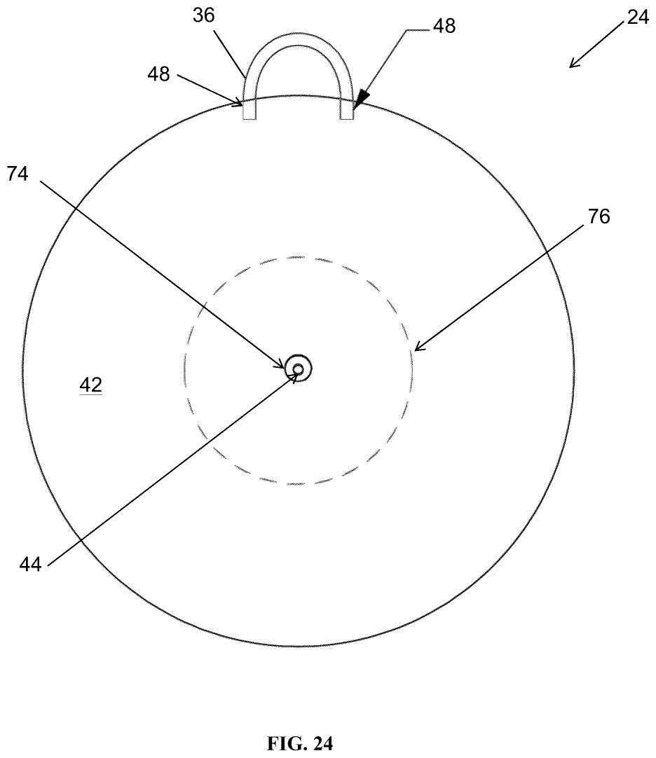

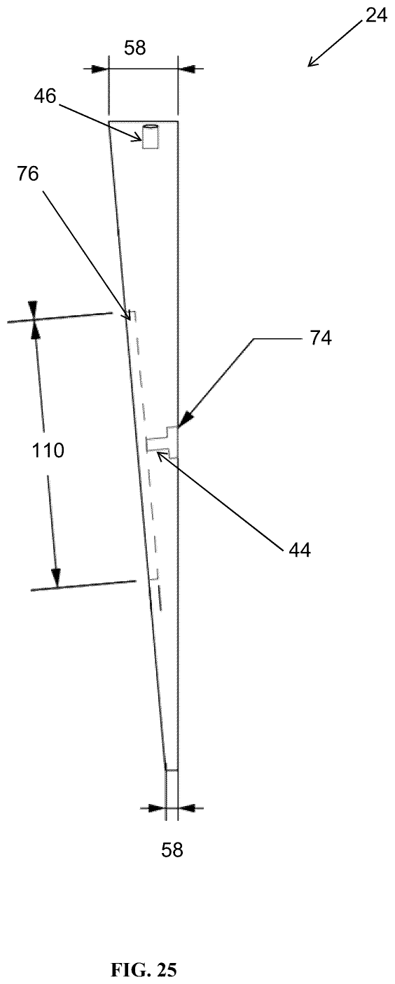

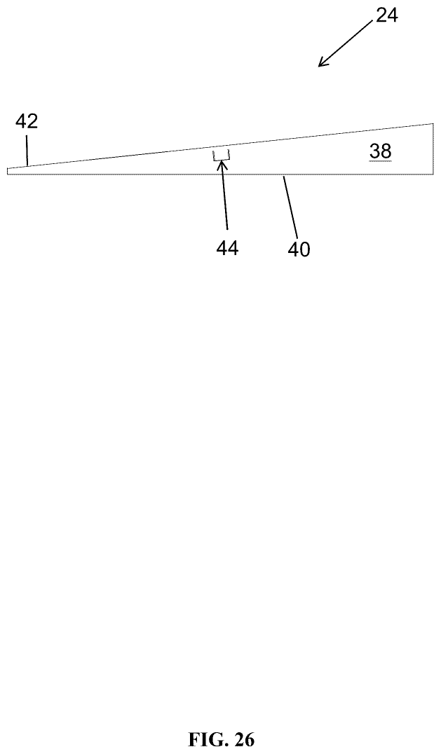

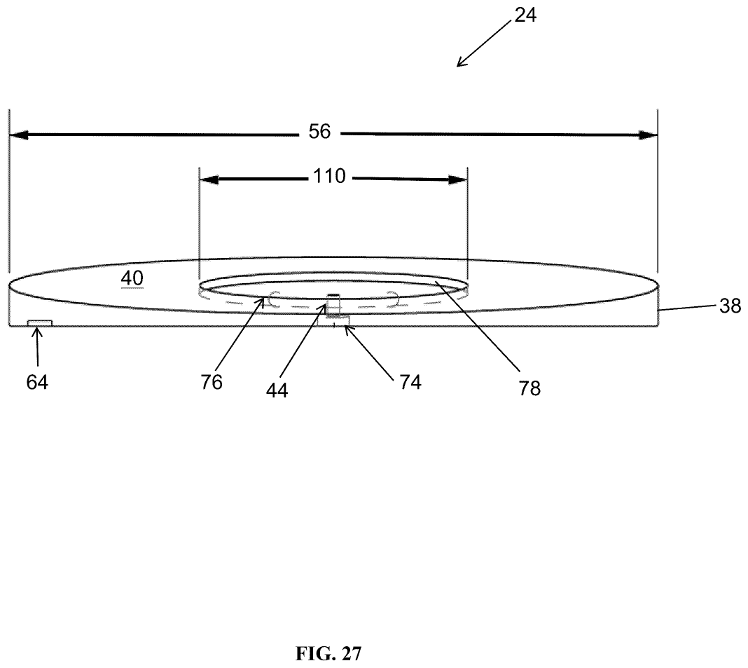

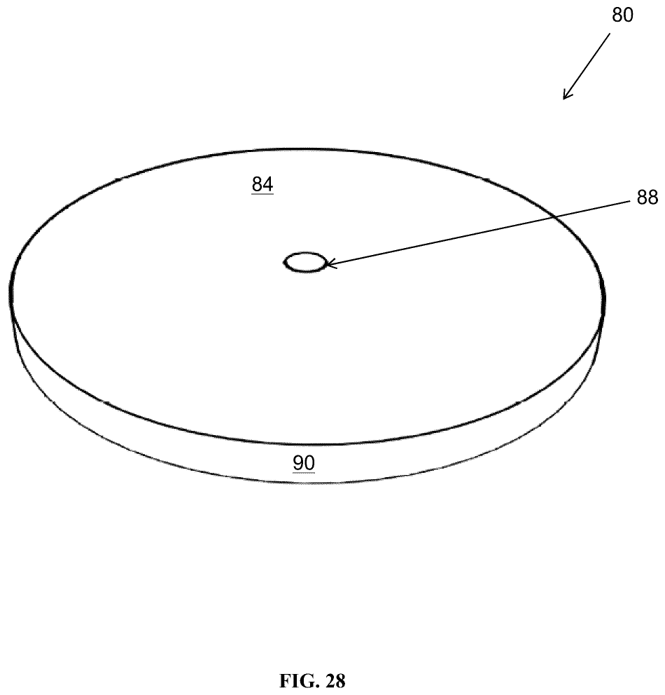

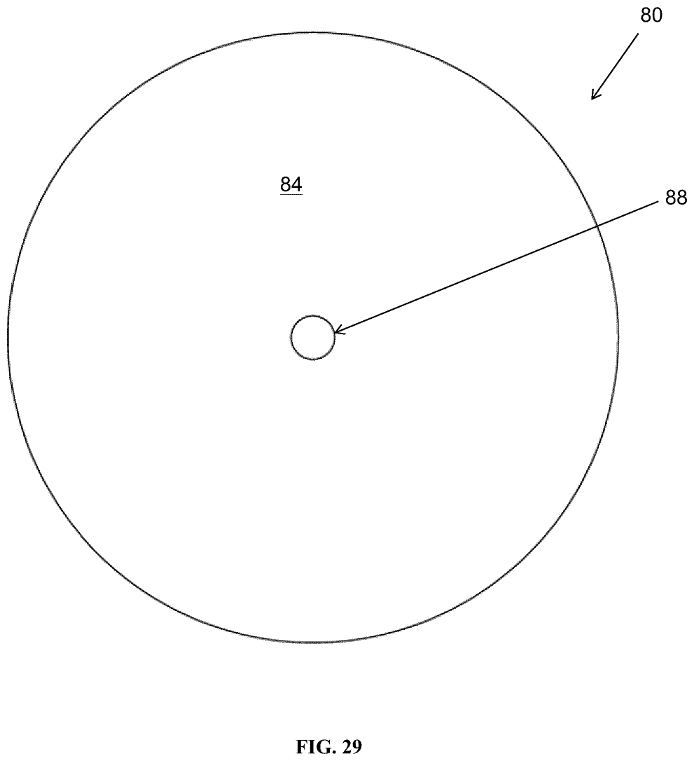

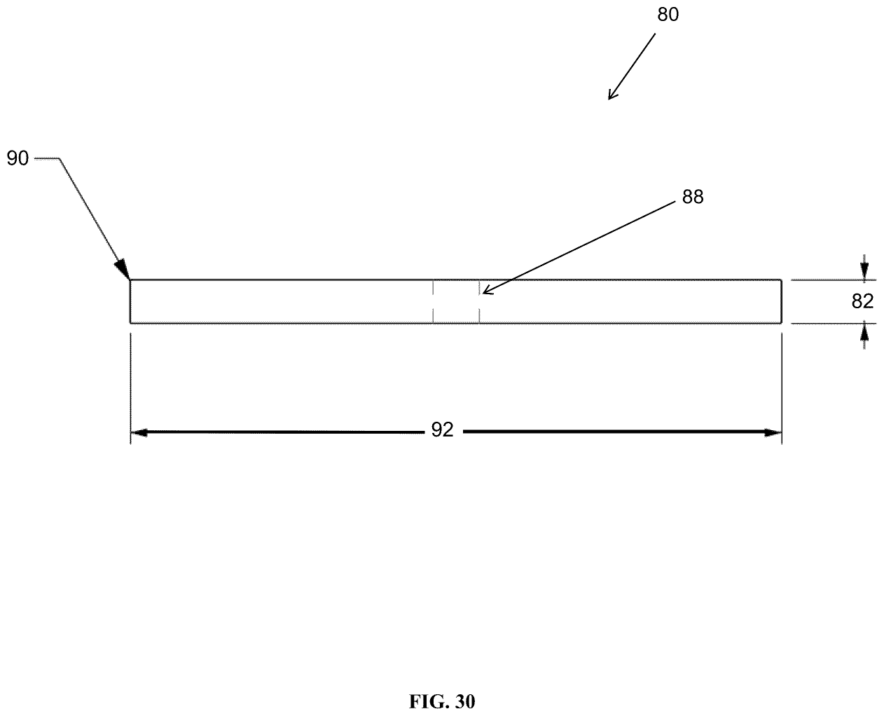

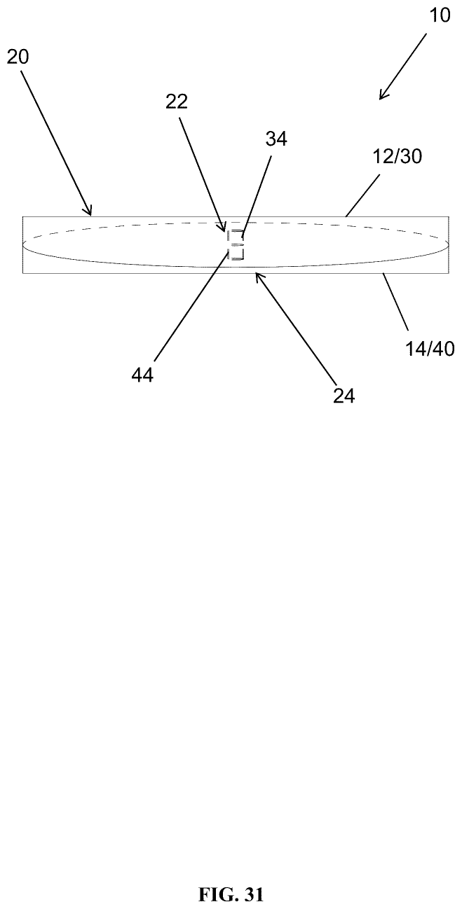

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively” or “operably”, such as when used as “operatively connected” or “operably engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of outriggers, stabilizers, jacks, similar items, or feet of any other equipment. However, the embodiments are not so limited. It is appreciated that the embodiments may be adapted for use in other applications, which may be improved by the disclosed structures, arrangements and/or methods. The system is merely shown and described as being used in the context of outriggers, stabilizers, jacks, similar items, or feet of any other equipment for ease of description and as one of countless examples.

### Equipment

In some various arrangements, the leveling pad system presented and described herein may be used in connection with various pieces of equipment, such as outriggers, stabilizers, jacks, or similar items. Such pieces of equipment may include a foot or any other type of surface which contacts the ground when the piece of equipment is in use. In one or more arrangements, as one example, the piece of equipment in use may be an outrigger, stabilizer, jack, or similar item of a crane, boom truck, aerial work platform, concrete pump truck, or similar vehicle. In this arrangement, as one example, the outrigger, stabilizer, jack, or similar item is configured to support the crane, boom truck, aerial work platform, concrete pump truck, or similar vehicle while in operation. In some various arrangements, the crane, boom truck, aerial work platform, concrete pump truck, or similar vehicle will create a heavy load which must be safely and securely supported by the outrigger, stabilizer, jack, or similar item.

In some various arrangements, the outrigger, stabilizer, jack, or similar item or piece of equipment will be located on a sloped surface. In some various arrangements, the outrigger, stabilizer, jack, or similar item or piece of equipment may be able to accommodate for some degree of slope, typically up to a 5-degree slope, however once the slope exceeds this angle then the foot of the piece of equipment may shear off or otherwise fail. In order to prevent this, the ground, floor, or other surface upon which the foot of the piece of equipment rests should be level prior to any load being placed on the foot of the piece of equipment. The leveling pad system described herein is configured to provide said level surface.

### Pads, Mats, Blocking, or Cribbing

In some various arrangements, the leveling pad system presented and described herein may be used in connection with a pad (such as an outrigger pad, a crane pad, or any other type of pad), mat, blocking, or cribbing. In some various arrangements, the pad, mat, blocking, or cribbing may be places onto the ground, floor, or other surface in order to distribute the load from the foot of the piece of equipment across a larger area, and once the pad, mat, blocking, or cribbing is places on the ground, floor, or other surface, the leveling pad system presented herein may be placed on top of the pad, mat, blocking, or cribbing. In these arrangements, the foot of the piece of equipment may then be placed on top of the leveling pad system.

In some various alternative arrangements, the leveling pad system presented herein may be placed on the ground, floor, or other surface and then a pad, mat, blocking, or cribbing may be placed on top of the leveling pad system. In these alternative arrangements, the foot of the piece of equipment may then be placed on top of the pad, mat, blocking, or cribbing.

While the leveling pad system may be used in connection with pads, mats, blocking, or cribbing, in some further alternative arrangements, as examples, the leveling pad system may be used without any pad, mat, blocking, or cribbing and the leveling pad system. In these further alternative arrangements, the leveling pad system may be simply placed on the ground, floor, or other surface and then the foot of the piece of equipment is placed on top of the leveling pad system.

### Leveling Pad System

With reference to the figures, a leveling pad system (or simply “system 10”) is presented. System 10 is formed of any suitable size, shape, and design and is configured to provide a level surface upon which a foot of a piece of equipment may rest. In one or more arrangements, as one example, system 10 has an upper surface 12, a lower surface 14, and an exterior surface 16. In one or more arrangements, as one example, system 10 includes a top member 20, an axle 22, a middle member 80 and a bottom member 24, among other components described herein. While system 10 has been described according to one or more arrangements, as one example, any combination or arrangement may be used and is hereby contemplated for use.

### Top Member 20:

In one or more arrangements, as one example, system 10 includes top member 20. Top member 20 is formed of any suitable size, shape, and design and is configured to provide a level surface which provides support to a foot of a piece of equipment and engage with bottom member 24. In one or more arrangements, as one example, top member 20 has an exterior surface 28, a top surface 30, a mating surface 32, a handle 36, and an aperture 34. In one or more arrangements as one example, top member 20 is formed of a single, unitary member that is formed in a manufacturing process such as molding, forming, additive manufacturing, or the like to form a unitary and monolithic member. Alternatively, top member 20 may be formed of multiple pieces that are connected or assembled to one another through adhesion, friction fitting, bolting, screwing, or any other means of connecting or assembling multiple pieces. In one or more arrangements, as one example, top member 20 is formed primarily of a non-metallic material, such as a plastic material, a fiberglass material, a composites material, or any other non-metallic material and/or composite thereof. Alternatively, top member 20 may be formed primarily of a metallic material, and/or any alloy or composite thereof. Exterior Surface and Top Surface: In one or more arrangements, as one example, top member 20 is a generally cylindrical member, having an exterior surface 28 which extends around in a circular manner to form a continuous, cylindrical exterior surface 28. In one or more arrangements, as one example, top member 20, and exterior surface 28, extend a height 50 from top surface 30 to mating surface 32. In one or more arrangements, as one example, top surface 30 is a generally flat and planar surface which generally forms a circle having a diameter 52 (or width 52), and top surface 30 meets exterior surface 28 at the exterior edge of the circular top surface 30. In one of the arrangements as shown, for example, the exterior surface has one or more connection members 48 configured to fit handle 36. The connection member may be circular as shown in the one arrangement for example, or any other size, shape, design or method of connecting the handle 36 to the top member 20.

Mating Surface: In one or more arrangements, as one example, mating surface 32 is a circular, planar surface that extends at an angle downward relative to top surface 30. In one or more arrangements, as one example, mating surface 32 extends at approximately a 5-degree angle downward relative to top surface 30, however any other degree angle downward relative to top surface 30 may be used such as, by way of example and not limitation, a 2-degree angle, a 6-degree angle, a 7-degree angle, a 10-degree angle, a 20-degree angle, and so on. That is, in one or more arrangements, as one example, at one side of top member 20, exterior surface 28 extends downward from top surface 30 a first distance until it meets mating surface 32, and at the opposing side of top member 20, exterior surface 28 extends downward from top surface 30 a second distance until it meets mating surface 32. In one or more arrangements, as one example, the first distance is less than the second distance, and this is due to the mating surface 32 extending at an angle downward relative to top surface 30.

In one of the arrangements shown, for example, mating surface 32 may have a recess 60 configured to fit all or a portion of the middle member 80. Recess 60 may have edge 62 configured to fit around exterior surface 90 of middle member 80. In one or more arrangements, as one example, recess 60 is a generally flat and planar surface which generally forms a circle having a diameter 64 (or width 64). Diameter 64 is less than diameter 52 of the top member. In one or more arrangements as shown, for example, recess 60 is in the middle of mating surface 32 and aperture 34 is in the center of recess 60. In one or arrangements shown edge 62 is shaped to fit around half the exterior surface 90 of the middle member. Recess 60 engages with top surface 84 of the middle member.

In one or more arrangements, as one example, mating surface 32 is formed of a material that has a high coefficient of friction such that when a foot of a piece of equipment exerts a heavy load on system 10, top member 20 and bottom member 24 will not slip relative to each other, they will stay in secured engagement due to the material of mating surface 32. Additionally or alternatively, in some various arrangements, as examples, mating surface 32 may include grip members, which are formed of a material having a high coefficient of friction such that when a foot of a piece of equipment experts a heavy load on system 10, top member 20 and bottom member 24 will not slip relative to each other, they will stay in secured engagement due to the material of the grip members on mating surface 32.

Aperture: In one or more arrangements, as one example, top member 20 includes an aperture 34. Aperture 34 is formed of any suitable size, shape, and design and is configured to allow axle 22 to extend a distance into top member 20. In one or more arrangements, as one example, aperture 34 extends from mating surface 32 upward a distance at an angle that is approximately perpendicular to mating surface 32. That is, aperture 34 begins at mating surface 32 and extends upward into top member 20 at an angle that is in an approximately perpendicular to mating surface 32. In one or more arrangements, as one example, aperture 34 does not extend all the way through top member 20 (i.e. aperture 34 does not extend from mating surface 32 to top surface 30), however in some various alternative arrangements, as examples, aperture 34 may extend any distance through top member 20, including all the way through top member 20 from mating surface 32 to top surface 30. In one or more arrangements shown, top surface 30 may have a recess 72 design to prevent axle 22 from sliding through aperture 34.

Level pocket: In one or more arrangements, for example, top member 20 may have a level pocket 64 configured to fit a bubble level 66 to detect an approximate level of top surface 30 of top member 20. Bubble level is configured to determine if top surface 30 is angled or flat. For example, if bubble level shows the approximate level of top surface 30 is angled, top member 20 may be rotated to decrease the angle of top surface 30.

Handle: In one or more arrangement shown, for example, top member 20 has a handle 36 configured to allow a user of the equipment pad system to rotate the top member 20, around axle 22, relative to a surface bottom member 24 is placed on, such as a floor, mat, pad, or any other surface where the bottom member 24 may be placed on. In one or more arrangements as shown handle 36 has a first end 68 and a second end 70, that may fit into connection members 48. In various arrangements, top member has only one connection member 48 and the first end 68 is inserted into the connection member. Handle 36 may be any design, size, or shape to facilitate a user's ability to rotate the top member and/or hold the equipment leveling system 10.

While in some arrangements may be primarily described with reference to top member 20 and its various components having a generally cylindrical member, any other shape or design of top member 20 and its various components may be utilized, including a square or rectangular shape or design, any elongated shape or design, a triangular shape or design, or any other shape, design, or configuration. It will be understood by those skilled in the art that any other size, shape, design, and/or configuration of top member 20 and its various components may be used in order to provide a level surface which provides support to a foot of a piece of equipment and engage with bottom member 24.

### Axle 22:

In one or more arrangements, as one example, system 10 includes axle 22. Axle 22 is formed of any suitable size, shape, and design and is configured to provide an axis about which top member 20 can rotate independent of bottom member 24 and also provide an axis about which bottom member 24 can rotate independent of top member 20. In one or more arrangements, as one example, axle 22 is a generally cylindrical, elongated member which extends a length between opposing ends.

In one or more arrangements, as one example, axle 22 is formed of a single, unitary member that is formed in a manufacturing process such as casting, extruding, machining, additive manufacturing, or the like to form a unitary and monolithic member. Alternatively, axle 22 may be formed of multiple pieces that are connected or assembled to one another through adhesion, welding, friction fitting, or any other means of connecting or assembling multiple pieces. For example, in one or more arrangements axle 22, may have a top member 100 and a bottom member 102. The top member 100 may extend through the top member 20, through the middle member 80 and through bottom member 24. Top member 100 is configured to fit through aperture 34 of the top member, aperture 88 of middle member 80, and aperture 44 of bottom member 24. In one or more arrangements, for example, top member 100 may have an upper portion 104 and a lower portion 106. Upper portion 104 may be designed to rest in a recess 72 in top surface 30 of top member. Upper portion 104 may be wider than lower portion 106 to prevent top member 100 from sliding through apertures 34, 44, and 88. Lower portion 106 may have smooth edges to facilitate rotation of top member 20, middle member 80 and bottom member 24 around the lower portion. A bottom member 102 of axle 22, is configured to attach to top member 100 and prevent the top member 20, middle member 80 and bottom member 24 from disconnecting from axle 22. Bottom member 102 is configured to fit in a recess 74 of bottom member 24 and has a width that is larger than a width of aperture 44 to prevent bottom member 102 from sliding into aperture 44. In one or more arrangements, for example, axle 22 may have attachment members 108 to fit between upper portion 104 and the top surface 30 and/or bottom member 102 and bottom surface 40 and is configured to keep top member 100 from loosening or to distribute the load from the top member 100 or bottom member 102 head over a larger area. In one or more arrangements top member 100 may be a nut and bottom member 102 may be a bolt, however this arrangement is not meant to be limiting. Axle 22, top member 100 and bottom member 102 may be any size, shape, or design that facilitates securing the top member 20, middle member 80 and bottom member 24 together and/or facilitating independent rotation. In one or more arrangements, as one example, axle 22 is formed primarily of a metallic material, or an alloy or composite thereof. Alternatively, axle 22 may be formed primarily of a non-metallic material, such as a plastic material, a fiberglass material, a composites material, or any other non-metallic material and/or composite thereof.

In one or more arrangements, as one example, axle 22 is configured to be inserted into the aperture 34 of top member 20 and the aperture 44 of bottom member 24. In one or more arrangements, as one example, when axle 22 is inserted into aperture 34 of top member 20, axle 22 extends through mating surface 32 of top member 20 in approximately a perpendicular manner. In this arrangement, as one example, top member 20 may rotate about the axis provided by axle 22 while still allowing for proper, secured engagement between mating surface 32 of top member 20 and mating surface 42 of bottom member 24. Likewise, in one or more arrangements, as one example, when axle 22 is inserted into aperture 44 of bottom member 24, axle 22 extends through mating surface 42 of bottom member 24 in approximately a perpendicular manner. In this arrangement, as one example, bottom member 24 may rotate about the axis provided by axle 22 while still allowing for proper, secured engagement between mating surface 42 of bottom member 24 and mating surface 32 of top member 20.

In another arrangement shown, as one example, axle 22 is configured to be inserted into the aperture 34 of top member 20, aperture 88 of middle member 80, and the aperture 44 of bottom member 24. In one or more arrangements, as one example, when axle 22 is inserted into aperture 34 of top member 20, axle 22 extends through mating surface 32 of top member 20 in approximately a perpendicular manner. In this arrangement, as one example, top member 20 may rotate about the axis provided by axle 22 while still allowing for proper, secured engagement between mating surface 32 of top member 20 and mating surface 42 of bottom member 24 as well as a top surface 84 of middle member 80. Likewise, in one or more arrangements, for example, when axle 22 is inserted into aperture 88 of middle member 80 and extends to bottom surface 86 of middle member in an approximately perpendicular manner. In this arrangement, as one example, middle member may rotate about the axis provided by axle 22 either independently of top member 20 and/or bottom member 24, or in the same direction as top member 20 and/bottom member 24, while still allowing for proper, secured engagement between mating surface 32 of top member 20 and mating surface 42 of bottom member 24 as well as a top surface 84 of middle member 80 and mating surface 32 of top member 20 and bottom surface 86 of middle member 80 and mating surface 42 of bottom member 24. Similarly, in one or more arrangements, as one example, when axle 22 is inserted into aperture 44 of bottom member 24, axle 22 extends through mating surface 42 of bottom member 24 in approximately a perpendicular manner. In this arrangement, as one example, bottom member 24 may rotate about the axis provided by axle 22 while still allowing for proper, secured engagement between mating surface 42 of bottom member 24 and mating surface 32 of top member 20.

While axle 22 has been described according to one or more arrangements, as one example, it will be understood by those skilled in the art that any other configuration of top member 20 may be used in order to provide an axis about which top member 20 can rotate independent of bottom member 24 and also provide an axis about which bottom member 24 can rotate independent of top member 20.

### Bottom Member 24:

In one or more arrangements, as one example, system 10 includes bottom member 24. Bottom member 24 is formed of any suitable size, shape, and design and is configured to provide a planar surface to set the ground, the floor, a pad, a mat, cribbing, blocking, or any other surface, as well as engage with top member 20 and help top member 20 have a level top surface 30. In one or more arrangements, as one example, bottom member 24 has an exterior surface 38, a bottom surface 40, a mating surface 42, a handle 36, and an aperture 44. In one or more arrangements as one example, bottom member 24 is formed of a single, unitary member that is formed in a manufacturing process such as molding, forming, additive manufacturing, or the like to form a unitary and monolithic member. Alternatively, bottom member 24 may be formed of multiple pieces that are connected or assembled to one another through adhesion, friction fitting, bolting, screwing, or any other means of connecting or assembling multiple pieces. In one or more arrangements, as one example, bottom member 24 is formed primarily of a non-metallic material, such as a plastic material, a fiberglass material, a composites material, or any other non-metallic material and/or composite thereof. Alternatively, bottom member 24 may be formed primarily of a metallic material, and/or any alloy or composite thereof.

Exterior Surface and Bottom Surface: In one or more arrangements, as one example, bottom member 24 is a generally cylindrical member, having an exterior surface 38 which extends around in a circular manner to form a continuous, cylindrical exterior surface 38. In one or more arrangements, as one example, bottom member 24, and exterior surface 38, extend a height 58 from bottom surface 40 to mating surface 42. In one or more arrangements, as one example, bottom surface 40 is a generally flat and planar surface which generally forms a circle having a diameter 56 (or width 56), and bottom surface 40 meets exterior surface 38 at the exterior edge of the circular bottom surface 40. In one of the arrangements as shown, for example, the exterior surface has one or more connection members 46 configured to fit handle 36. The connection member 46 may be circular as shown in the one arrangement for example, or any other size, shape, design or method of connecting the handle 36 to the bottom member 24.

Mating Surface: In one or more arrangements, as one example, mating surface 42 is a circular, planar surface that extends at an angle upward relative to bottom surface 40. In one or more arrangements, as one example, mating surface 42 extends at approximately a 5-degree angle upward relative to bottom surface 40, however any other degree angle downward relative to bottom surface 40 may be used such as, by way of example and not limitation, a 2-degree angle, a 6-degree angle, a 7-degree angle, a 10-degree angle, a 20-degree angle, and so on. That is, in one or more arrangements, as one example, at one side of bottom member 24, exterior surface 38 extends upward from bottom surface 40 a first distance until it meets mating surface 42, and at the opposing side of bottom member 24, exterior surface 38 extends upward from bottom surface 40 a second distance until it meets mating surface 42. In one or more arrangements, as one example, the first distance is less than the second distance, and this is due to the mating surface 42 extending at an angle upward relative to bottom surface 40.

In one of the arrangements shown, for example, mating surface 42 may have a recess 76 configured to fit all or a portion of the middle member 80. Recess 76 may have edge 78 configured to fit around exterior surface 90 of middle member 80. In one or more arrangements, as one example, recess 76 is a generally flat and planar surface which generally forms a circle having a diameter 110 (or width 110). Diameter 110 is less than diameter 56 of the bottom member 24. In one or more arrangements, for example, recess 76 is in the middle of mating surface 42 and aperture 44 is in the center of recess 76. In one or arrangements shown edge 78 is shaped to fit around half the exterior surface 90 of the middle member. Recess 76 engages with bottom surface 86 of the middle member.

In one or more arrangements, as one example, mating surface 42 is formed of a material that has a high coefficient of friction such that when a foot of a piece of equipment exerts a heavy load on system 10, top member 20 and bottom member 24 will not slip relative to each other, they will stay in secured engagement due to the material of mating surface 42. Additionally or alternatively, in some various arrangements, as examples, mating surface 42 may include grip members which are formed of a material having a high coefficient of friction such that when a foot of a piece of equipment experts a heavy load on system 10, top member 20 and bottom member 24 will not slip relative to each other, they will stay in secured engagement due to the material of the grip members on mating surface 42.

Aperture: In one or more arrangements, as one example, bottom member 24 includes aperture 44. Aperture 44 is formed of any suitable size, shape, and design and is configured to allow axle 22 to extend a distance into bottom member 24. In one or more arrangements, as one example, aperture 44 extends from mating surface 42 downward a distance at an angle that is approximately perpendicular to mating surface 42. That is, aperture 44 begins at mating surface 42 and extends downward into bottom member 24 at an angle that is in an approximately perpendicular to mating surface 42. In one or more arrangements, as one example, aperture 44 does not extend all the way through bottom member 24 (i.e. aperture 44 does not extend from mating surface 42 to bottom surface 40), however in some various alternative arrangements, as examples, aperture 44 may extend any distance through bottom member 24, including all the way through bottom member 24 from mating surface 42 to bottom surface 40.

While some arrangements may be primarily described with reference to bottom member 24 and its various components having a generally cylindrical member, any other shape or design of bottom member 24 and its various components may be utilized, including a square or rectangular shape or design, any elongated shape or design, a triangular shape or design, or any other shape, design, or configuration. It will be understood by those skilled in the art that any other size, shape, design, and/or configuration of bottom member 24 and its various components may be used in order to provide a planar surface to set the ground, the floor, a pad, a mat, cribbing, blocking, or any other surface, as well as engage with top member 20 and help top member 20 have a level top surface 30. In one or more arrangements shown, bottom surface 40 may have a recess 74 design to prevent axle 22 from sliding through aperture 44.

Level pocket: In one or more arrangements shown, for example, top 20 may have a level pocket 64 configured to fit a bubble level 66 to detect an approximate level of top surface 30 of top member 20. Bubble level 66 is configured to determine if top surface 30 is angled or flat. For example, if bubble level shows the approximate level of top surface 30 is angled, top member 20 may be rotated to decrease the angle of top surface 30 or bottom member 24 may be rotated to decrease the angle of top surface 30. Likewise, if the bubble level 66 shows that an angle of the top surface 30 needs to be greater, bottom member 24 or top member 20 may be rotated till the bubble level 66 shows approximate level desired.

Handle: In one or more arrangements shown, for example, bottom member 24 has a handle 36 configured to allow a user of the equipment pad system to rotate bottom member 24, around axle 22, relative to a surface bottom member 24 is placed on, such as a floor, mat, pad, or any other surface where the bottom member 24 may be placed on. In one or more arrangements, handle 36 has a first end 68 and a second end 70, that may fit into connection members 48. In various arrangements, bottom member 24 has only one connection member 48 and the first end 68 is inserted into the connection member. Handle 36 may be any design, size, or shape to facilitate a user's ability to rotate the bottom member 24 and/or hold the equipment leveling system 10.

### Middle Member 80

In one or more arrangements, as one example, system 10 includes middle member 80. Middle member 80 is formed of any suitable size, shape, and design and is configured to provide a planar surface to engage with top member 20 to help top member 20 have a level top surface 30, engage with bottom member 24, as well as taking any pressure from potential lateral movement from at least the top member 20, bottom member 24, or an object placed on system 10. In one or more arrangements, as one example, middle member has an exterior surface 90 having a height 82, a bottom surface 86, a top surface 84, and an aperture 88. In one or more arrangements, as one example, when top member 20 is placed on middle member 80 and bottom member 24, middle member 80 is not visible.

In one or more arrangements, as one example, middle member 80 is formed of a single, unitary member that is formed in a manufacturing process such as molding, forming, additive manufacturing, or the like to form a unitary and monolithic member. Alternatively, middle member 80 may be formed of multiple pieces that are connected or assembled to one another through adhesion, friction fitting, bolting, screwing, or any other means of connecting or assembling multiple pieces. In one or more arrangements shown, as one example, middle member 80 is formed primarily of a non-metallic material, such as a plastic material, a fiberglass material, a composites material, or any other non-metallic material and/or composite thereof. Alternatively, middle member 80 may be formed primarily of a metallic material, and/or any alloy or composite thereof.

Exterior Surface, Bottom Surface and Top Surface: In one or more arrangements, as one example, middle member is a generally cylindrical member, having an exterior surface 90 which extends around in a circular manner to form a continuous, cylindrical exterior surface 90. In one or more arrangements, as one example, middle member, and exterior surface 90, extend a height 82 from bottom surface 86 to top surface 84. In one or more arrangements, as one example, bottom surface 86 and top surface 84 are generally flat and planar surfaces which generally form a circle having a diameter 92 (or width 92), and bottom surface 86 meets exterior surface 90 at the exterior edge of the circular bottom surface 86. Likewise, top surface 84 meets exterior surface 90 at the exterior edge of the circular top surface 84. In one or more arrangements, as one example, where bottom surface 86 meets exterior surface 90, the edge is deburred and eased. Likewise, in one or more arrangements, as one example, where top surface 84 meets exterior surface 90, the edge is deburred and eased.

In one or more arrangements, as one example, top surface 84 and bottom surface 86 are formed of a material that has a high coefficient of friction such that when a foot of a piece of equipment exerts a heavy load on system 10, top member 20, middle member 80 and bottom member 24 will not slip relative to each other, they will stay in secured engagement due to the material of top surface 84 and/or bottom surface 86. Additionally or alternatively, in some various arrangements, as examples, top surface 84 and/or bottom surface 86 may include grip members which are formed of a material having a high coefficient of friction such that when a foot of a piece of equipment experts a heavy load on system 10, top member 20, middle member 80 and bottom member 24 will not slip relative to each other, they will stay in secured engagement due to the material of the grip members on top surface 84 and/or bottom surface 86.

Aperture: In one or more arrangements, as one example, middle member 80 includes aperture 88. Aperture 88 is formed of any suitable size, shape, and design and is configured to allow axle 22 to extend a distance into middle member 80 or through middle member 80. In one or more arrangements, as one example, aperture 88 extends from top surface 84 downward a distance at an angle that is approximately perpendicular to top surface 84. That is, aperture 88 begins at top surface 84 and extends downward into middle member 80 at an angle that is approximately perpendicular to top surface 84. In one or more arrangements, as one example, aperture 88 extends all the way through middle member 80. However, in some various alternative arrangements, as examples, aperture 88 may extend any distance through middle member 80, including, as one example, a first distance from the top surface downward through middle member 80, ending in middle member 80. Likewise, aperture 88 may extend any distance from bottom surface 86 through middle member, ending in middle member 80. The two apertures 88 may be in line with each other, or in different locations on middle member 80.

While some arrangements may be primarily described with reference to middle member 80 and its various components having a generally cylindrical member, any other shape or design of middle member 80 and its various components may be utilized, including a square or rectangular shape or design, any elongated shape or design, a triangular shape or design, or any other shape, design, or configuration. It will be understood by those skilled in the art that any other size, shape, design, and/or configuration of middle member 80 and its various components may be used in order to provide surface to engage with top member 20 to help top member 20 have a level top surface 30, engage with bottom member 24, as well as taking any pressure from potential lateral movement from at least the top member 20, bottom member 24, or an object placed on system 10.

### Angles of Mating Surface 32 and Mating Surface 42:

In one or more arrangements, as one example, and as described herein, mating surface 32 of top member 20 extends at an angle downward relative to top surface 30 of top member 20 and mating surface 42 of bottom member 24 extends at an angle upward relative to bottom surface 40 of bottom member 24. In one or more arrangements, as one example, the angles at which mating surface 32 extends downward and mating surface 42 extends upward is 5-degrees. In one or more arrangements, as one example, with the angle of mating surface 32 and mating surface 42 being 5-degrees, system 10 is able to rest on a 10-degree angled sloped surface and still provide a level surface for a foot of a piece of equipment. That is, in one or more arrangements as one example, system 10 may be adjusted to accommodate and make up for a slope of 10-degrees in order to provide a flat surface for a foot of a piece of equipment to rest on.

While the angles of mating surface 32 and mating surface 42 have been shown and described herein as 5-degree angles, mating surface 32 and mating surface 42 are not so limited. For example, in one or more arrangements, the angle at which mating surface 32 extends downward and mating surface 42 extends upward is 10-degrees and, in such arrangements, system 10 is able to rest on a 20-degree angled sloped surface and still provide a level surface for a foot of a piece of equipment. In some various alternative arrangements, as examples, the angles of mating surface 32 and mating surface 42 may be any other angle that is desired or needed in order to provide a level surface for a foot of a piece of equipment.

Assembly and Method of Use: System 10 is configured to be assembled at a job site or a desired location. System 10 is operated by placing the bottom surface 40 of bottom member 24 on the ground, floor, mat, or other surface. Axle 22 may then be placed in the aperture 44 of bottom member 24. When axle 22 is placed in the aperture 44 of bottom member 24, axle 22 will extend upward past the mating surface 42 of bottom member 24 at an angle approximately perpendicular to the mating surface. With axle 22 extending upward past mating surface 42, top member 20 may then be placed on top of bottom member. More specifically, the mating surface 32 of top member 20 is placed onto the mating surface 42 of bottom member 24 such that axle 22 is inserted into the aperture 34 of top member 20. At this point, system 10 is assembled and ready to be adjusted.

In one or more arrangements, as one example, system 10 is configured to be assembled at a job site or a desired location. System 10 is operated by placing the bottom surface 40 of bottom member 24 on the ground, floor, mat, or other surface. Middle member 80 is placed in recess 76, with aperture 88 in alignment with aperture 44. Top member 20 is placed on top of middle member 80, where middle member 80 is within recess 60 of the mating surface 32 of top member 20. Aperture 88 is in alignment with aperture 34. Axle 22 is placed in aperture 34 and extends downward through aperture 88 to aperture 44. Axle 22 runs at an angle approximately perpendicular to the mating surface 32 of top member 20, top surface 84 of middle member 80, and mating surface 42 of bottom member 24. In some arrangements, a top member 100 of axle 22 is placed in aperture 34 and extends downwards through aperture 88 to aperture 44. Bottom member 102 is attached to Top member 100 securing axle 22 and is configured to prevent top member 20, middle member 80, and bottom member 24 from sliding away from each other. At this point, system 10 is assembled and ready to be adjusted.

When system 10 is assembled at a desired location, system 10 can be adjusted to provide a level surface for a foot of a piece of equipment to rest on. In one or more arrangements, as one example, system 10 may be placed on a sloped surface and the foot of the piece of equipment needs a flat and level surface to rest on. In one or more arrangements, as one example, system 10 may be adjusted to provide a flat and level surface. That is, in one or more arrangements, as one example, system 10 can be adjusted to make up for the sloped surface. In one or more arrangements, as one example, bottom member 24 of system 10 may be configured to rotate about axle 22 independent of top member 20 to a desired position, at which the top surface 30 of top member 20 is level in a first direction. In one or more arrangements, as one example, handle 36 may aid in rotating bottom member 24 to the desired position. Further, in one or more arrangements, as one example, top member 20 of system 10 may be rotated about axle 22 independent of bottom member 24 to a desired position, at which the top surface 30 of top member 20 is level in a second direction. In one or more arrangements, as one example, handle 36 may aid in rotating top member 20 to the desired position.

In one or more arrangements, as one example, once system 10 is assembled and placed on the ground, floor, mat, or other surface, a user may use a bubble level 66 in order to determine whether the top surface 30 of top member 20 is level in both a first direct and a second direction. Typically, bubble levels include a see-through exterior with liquid and an air bubble inside. Additionally, on the exterior of the bubble level there are typically markings, and the markings define a center area. If the air bubble is partially or wholly within the center area of the bubble level, then the surface upon which the bubble level is resting is approximately level.

If the user determines the top surface 30 of top member 20 is not level in a first direction, bottom member 24 may be rotated about axle 22 and independent of top member 20 until bottom member 24 is in a desired position. When bottom member 24 is rotated, mating surface 32 and mating surface 42 interact such that the top surface 30 of top member 20 is tilted upward or downward, depending on the direction of rotation of bottom member 24. The user can then place the bubble level on the top surface 30 of top member 20 again to determine if the top surface 30 is approximately level. In one or more arrangements, as one example when the bubble level is placed on top surface 30 and the air bubble in the bubble level is partially or wholly within the center area of the bubble level, top surface 30 is approximately level in the first direction.

In one or more arrangements, as one example, middle member 80 may rotate with bottom member 24 when bottom member 24 rotates. In one or more arrangements, as one example, middle member 80 may rotate with top member when top member 20 rotates. In one or more arrangements, as one example, middle member 80 may rotate independently from top member 20 and/or bottom member 24. In one or more arrangements, as one example, middle member 80 may be stationary while top member 20 and/or bottom member 24 rotates.

In one or more arrangements, as one example, (with mating surface 32 and mating surface 42 extend at 5-degree angles), rotating bottom member 24 independent of top member 20 a total of 45-degrees will result in top surface 30 tilting upward or downward 2.5-degrees in the first direction. In this example arrangement, as one example, rotating bottom member 24 independent of top member 20 a total of 90-degrees will result in top surface 30 tilting upward or downward 5-degrees in the first direction. In this arrangement, as one example, rotating bottom member 24 independent of top member 20 a total of 135-degrees will result in top surface 30 tilting upward or downward 7.5-degrees in the first direction. In this arrangement, as one example, rotating bottom member 24 independent of top member 20 a total of 180-degrees will result in top surface 30 tilting upward or downward 10-degrees in the first direction. In this arrangement, when rotating bottom member 24 any other degrees from the starting position, top surface 30 will tilt a corresponding degree in the first direction.

If the user determines the top surface 30 of top member 20 is not level in a second direction (such as the direction perpendicular to the first direction), either before or after rotating the bottom member 24, the user can rotate top member 20 to achieve a level top surface 30 in the second direction. In one or more arrangements, as one example, the user can rotate top member 20 about axle 22 independent of bottom member 24 until bottom member 24 is in a desired position. When top member 20 is rotated to the desired position, the top surface 30 of top member 20 is tilted upward or downward, depending on the direction of rotation of top member 20. The user can then place the bubble level on the top surface 30 of top member 20 again to determine if the top surface 30 is approximately level (meaning the air bubble in the bubble level is in the center area).

In one or more arrangements, as one example, (with mating surface 32 and mating surface 42 extend at 5-degree angles), rotating top member 20 independent of bottom member 24 a total of 45-degrees will result in top surface 30 tilting upward or downward 2.5-degrees in the second direction. In this arrangement, as one example, rotating top member 20 independent of bottom member 24 a total of 90-degrees will result in top surface 30 tilting upward or downward 5-degrees in the second direction. In this arrangement, as one example, rotating top member 20 independent of bottom member 24 a total of 135-degrees will result in top surface 30 tilting upward or downward 7.5-degrees in the second direction. In this arrangement, as one example, rotating top member 20 independent of bottom member 24 a total of 180-degrees will result in top surface 30 tilting upward or downward 10-degrees in the second direction. In this arrangement, when rotating top member 20 any other degrees from the starting position, top surface 30 will tilt a corresponding degree in the second direction.

Once the user determines that the top surface 30 of top member 20 is level in a first direction and level in a second direction, then the foot of the piece of equipment may be lowered or placed onto the top surface 30 of top member 20 and the piece of equipment can be used in a safe and secure manner.

While system 10 may be primarily used to provide a level surface for a foot of a piece of equipment, system 10 is not so limited. In some various other arrangements, a user may desire that top surface 30 of top member 20 has a desired slope in a first direction and a desired slope in a second direction. System 10 may be used to provide such desired slopes and the method of operating system 10 is similar to that described above, with the only difference being that the user rotates the top member 20 and/or the bottom member 24 until top surface 30 of top member 20 is at the desired slope in the first direction and at the desired slope in the second direction. Again, the desired slope does not need to be level, the desired slope may be any angle or slope that is able to be accommodated by the angles of mating surface 32 and mating surface 42. That is, the desired slope may be anywhere from 0 to 10-degrees when the angle of mating surface 32 and mating surface 42 is 5-degrees. Likewise, the desired slope may be anywhere from 0 to 20-degrees when the angle of mating surface 32 and mating surface 42 is 10-degrees, and so on and so forth.

### Additional Attachments

In some various arrangements, as examples, system 10 may also include additional attachments. In one or more arrangements, as examples, top member 20 and bottom member 24 may include handles in order to easily transport, carry, and rotate top member 20 and bottom member 24. In one or more arrangements, as examples, one or more bubble levels 66 may be directly built into top member 20. That is, in one or more arrangements, top member 20 may have one or more recesses 64 or level pockets 64 configured to receive and hold one or more bubble levels, and the bubble levels will show whether top surface 30 of top member 20 is level in a direction (such as a first direction and a second direction).

From the above discussion it will be appreciated that system 10 presented herein improves upon the state of the art. Specifically, in one or more arrangements, a leveling pad system 10 and method of use is presented which: improves upon the state of the art; is safe to operate; is rigid and does not fail or slip when placed under heavy loads; provides a level and stable base when in use; is relatively easy to build; is relatively friendly to build; can be built relatively quickly and efficiently; is easy to operate; is relatively cost friendly to manufacture; is relatively easy to transport; is aesthetically appealing; is robust; is easy to adjust; is relatively inexpensive; is not easily susceptible to wear and tear; has a long useful life; and/or is efficient to use and operate.

What is claimed:

1. A leveling pad system, comprising:
a top member;
the top member having a top surface;
the top member having a mating surface;
wherein the mating surface of the top member extends at an angle downward relative to the top surface;
a bottom member;
the bottom member having a bottom surface;
the bottom member having a mating surface;
wherein the mating surface of the bottom member extends at an angle upward relative to the top surface;
an axle;
the axle extending a length between a first end and a second end;
wherein the axle is configured to be inserted into the top member and the bottom member;
wherein the bottom surface of the bottom member is configured to rest on a surface;
wherein the top surface of the top member is configured to receive and support a foot of a piece of equipment;
wherein the top member is configured to rotate about the axle independent of the bottom member and the bottom member is configured to rotate about the axle independent of the top member;
wherein when the bottom member is rotated about the axle the top surface of the top member moves to a desired slope in a first direction and when the top member is rotated about the axle the top surface of the top member moves to a desired slope in a second direction.

2. The leveling pad system of claim 1, wherein the surface is a piece of ground, a floor, a pad, a mat, blocking, or cribbing.

3. The leveling pad system of claim 1, wherein the piece of equipment is an outrigger, stabilizer, or jack of a crane, a boom truck, an aerial work platform, or a concrete pump truck.

4. The leveling pad system of claim 1, wherein the foot is a foot of an outrigger and wherein the outrigger is configured to provide support to the piece of equipment when in operation.

5. The leveling pad system of claim 1, wherein the mating surface of the top member extends at approximately a 5-degree angle downward relative to the top surface of the top member.

6. The leveling pad system of claim 1, wherein the mating surface of the bottom member extends at approximately a 5-degree angle upward relative to the bottom surface of the bottom member.

7. The leveling pad system of claim 1, wherein the axle extends in a perpendicular manner relative to the mating surface of the top member and the mating surface of the bottom member.

8. The leveling pad system of claim 1, wherein when the bottom member is rotated such that the top surface of the top member is at the desired slope in the first direction the top surface of the top member is approximately level in the first direction.

9. The leveling pad system of claim 1, wherein when the top member is rotated such that the top surface of the top member is at the desired slope in the second direction the top surface of the top member is approximately level in the second direction.

10. The leveling pad system of claim 1, wherein the surface is a sloped surface, wherein when the bottom member is rotated to the desired slope the top surface of the top member is level in the first direction, and when the top member is rotated to the desired slope the top surface of the top member is level in the second direction.

11. The leveling pad system of claim 1, wherein the mating surface of the top member is configured to engage with the mating surface of the bottom member and the mating surface of the top member and the mating surface of the bottom member hold the top member and bottom member in secured engagement.

12. A leveling pad system, comprising:
a top member;
the top member having a top surface;
the top member having a mating surface;
wherein the mating surface of the top member extends at an angle downward relative to the top surface;
a bottom member;
the bottom member having a bottom surface;
the bottom member having a mating surface;
wherein the mating surface of the bottom member extends at an angle upward relative to the top surface;
an axle;
the axle extending a length between a first end and a second end;
wherein the axle is configured to be inserted into the top member and the bottom member;
wherein the bottom surface of the bottom member is configured to rest on a sloped surface;
wherein the top surface of the top member is configured to receive and support a foot of a piece of equipment;
wherein the top member is configured to rotate about the axle independent of the bottom member and the bottom member is configured to rotate about the axle independent of the top member;
wherein when the bottom member is rotated about the axle to a desired position, the top surface of the top member is approximately level in a first direction and when the top member is rotated about the axle to a desired position the top surface of the top member is approximately level in a second direction.

13. The leveling pad system of claim 12, wherein the sloped surface is a piece of ground, a floor, a pad, a mat, blocking, or cribbing.

14. The leveling pad system of claim 12, wherein the piece of equipment is an outrigger, stabilizer, or jack of a crane, a boom truck, an aerial work platform, or a concrete pump truck.

15. The leveling pad system of claim 12, wherein the foot is a foot of an outrigger and wherein the outrigger is configured to provide support to the piece of equipment when in operation.

16. The leveling pad system of claim 12, wherein the angle at which the mating surface of the top member extends downward at is a 5-degree angle relative to the top surface of the top member.

17. The leveling pad system of claim 12, wherein the angle at which the mating surface of the bottom member extends upward at is a 5-degree angle relative to the bottom surface of the bottom member.

18. The leveling pad system of claim 12, wherein the mating surface of the top member is configured to engage with the mating surface of the bottom member and the mating surface of the top member and the mating surface of the bottom member hold the top member and bottom member in secured engagement.

19. A method of using a leveling pad system, the method comprising:
providing a leveling pad;
the leveling pad having a top member with a top surface and a mating surface;
the leveling pad having a bottom member with a bottom surface and a mating surface;
the leveling pad having an axle extending through the top member and the bottom member of the leveling pad;
placing the bottom surface of the bottom member of the leveling pad on a sloped surface;
placing the axle into an aperture in the mating surface of the bottom member;
aligning the axle with an aperture in the mating surface of the top member and lowering the mating surface of the top member onto the mating surface of the bottom member;
rotating the bottom member to a desired position such that the top surface of the top member is approximately level in a first direction;
rotating the top member to a desired position such that the top surface of the top member is approximately level in a second direction;
placing a foot of a piece of equipment on the top surface of the top member of the leveling pad.

20. A leveling pad system, comprising:
a top member;
the top member having a top surface;
the top member having a mating surface;
wherein the mating surface of the top member extends at an angle downward relative to the top surface;
a bottom member;
the bottom member having a bottom surface;
the bottom member having a mating surface;
wherein the mating surface of the bottom member extends at an angle upward relative to the top surface;
a middle member;
the middle member having a top surface;
the middle member having a bottom surface;
an axle;
the axle extending a length between a first end and a second end;
wherein the axle is configured to be inserted into the top member, the middle member and the bottom member;
wherein the bottom surface of the bottom member is configured to rest on a surface;
wherein the top surface of the top member is configured to receive and support a foot of a piece of equipment;
wherein the top member is configured to rotate about the axle independent of the bottom member and the bottom member is configured to rotate about the axle independent of the top member;
wherein when the bottom member is rotated about the axle the top surface of the top member moves to a desired slope in a first direction and when the top member is rotated about the axle the top surface of the top member moves to a desired slope in a second direction.

21. The leveling pad system of claim 20, wherein the surface is a piece of ground, a floor, a pad, a mat, blocking, or cribbing.

22. The leveling pad system of claim 20, wherein the piece of equipment is an outrigger, stabilizer, or jack of a crane, a boom truck, an aerial work platform, or a concrete pump truck.

23. The leveling pad system of claim 20, wherein the foot is a foot of an outrigger and wherein the outrigger is configured to provide support to the piece of equipment when in operation.

24. The leveling pad system of claim 20, wherein the mating surface of the top member extends at approximately a 5-degree angle downward relative to the top surface of the top member.

25. The leveling pad system of claim 20, wherein the mating surface of the bottom member extends at approximately a 5-degree angle upward relative to the bottom surface of the bottom member.

26. The leveling pad system of claim 20, wherein the axle extends in a perpendicular manner relative to the mating surface of the top member and the mating surface of the bottom member.

27. The leveling pad system of claim 20, wherein when the bottom member is rotated such that the top surface of the top member is at the desired slope in the first direction the top surface of the top member is approximately level in the first direction.

28. The leveling pad system of claim 20, wherein when the top member is rotated such that the top surface of the top member is at the desired slope in the second direction the top surface of the top member is approximately level in the second direction.

29. The leveling pad system of claim 20, wherein the surface is a sloped surface, wherein when the bottom member is rotated to the desired slope the top surface of the top member is level in the first direction, and when the top member is rotated to the desired slope the top surface of the top member is level in the second direction.

30. The leveling pad system of claim 20, wherein the mating surface of the top member is configured to engage with the mating surface of the bottom member and the mating surface of the top member and the mating surface of the bottom member hold the top member and bottom member in secured engagement.

31. The leveling pad system of claim 20, wherein the mating surface of the top member has a recess configured to fit at least the top surface of middle member.

32. The leveling pad system of claim 20, wherein the mating surface of the bottom member has a recess configured to fit at least the bottom surface of middle member.

33. The leveling pad system of claim 20, wherein the mating surface of the top member has a recess configured to fit at least the top surface of middle member; and
wherein the mating surface of the bottom member has a recess configured to fit at least the bottom surface of middle member.

34. The leveling pad system of claim 20, wherein the middle member has an aperture extending from the top surface of the middle member to the bottom surface of the middle member and is configured to fit the axle.

35. The leveling pad system of claim 20, wherein the middle member rotates independently of the top member.

36. The leveling pad system of claim 20, wherein the middle member rotates independently from the bottom member.

37. The leveling pad system of claim 20, wherein the top member has a handle configured to allow a user of the leveling pad system to rotate the top member.

38. The leveling pad system of claim 20, wherein the bottom member has a handle configured to allow a user of the leveling pad system to rotate the bottom member.

39. The leveling pad system of claim 20, wherein the axle comprises a top member and a bottom member.

40. A method of using a leveling pad system, the method comprising:
providing a leveling pad;
the leveling pad having a top member with a top surface and a mating surface;
the leveling pad having a bottom member with a bottom surface and a mating surface;
the leveling pad having a middle member with a top surface and a bottom surface;
the leveling pad having an axle extending through the top member, the middle member and the bottom member of the leveling pad;
placing the bottom surface of the bottom member of the leveling pad on a sloped surface;
placing a bottom surface of the middle member in a recess of the mating surface of the bottom member;
aligning an aperture of the bottom member with an aperture of the middle member;
placing the top member on the middle member and the bottom member, wherein a recess of the mating surface of the top member is placed on the top surface of the middle member, and the mating surface of the top member is placed on the mating surface of the bottom member;
aligning an aperture of the top member with the aperture of the bottom member;
aligning the axle with the aperture of the top member;
inserting the axle into the aperture of the top member through the aperture of the middle member and into the aperture of the bottom member;
rotating the bottom member to a desired position such that the top surface of the top member is approximately level in a first direction;
rotating the top member to a desired position such that the top surface of the top member is approximately level in a second direction;
placing a foot of a piece of equipment on the top surface of the top member of the leveling pad.

41. The method of claim 40, further comprising:
securing the axle such that a top member of the axle is inserted into the aperture of the top member through the aperture of the middle member and into the aperture of the bottom member and a bottom member of the axle is attached to the top member of the axle at the bottom surface of the bottom member to prevent the top member, middle member and bottom member from disengaging from the axle.
